(19) United States
(12) Patent Application Publication
(10) Pub. No.: US 2007/0007384 A1
(43) Pub. Date: Jan. 11, 2007

(54) Physical threat containment, neutralization and protection means applicable to terrorism, combat and disaster mitigation

(76) Inventor: John W. Sliwa JR., Los Altos, CA (US)

Correspondence Address: David W. Collins;Intellectual Property Law, #100, 512 E. Whitehouse Canyon Rd, Green Valley, AZ, 85614, US

(21) Appl. No.: 11/304,449

(22) Filed: Dec. 14, 2005

Related U.S. Application Data
(60) Provisional application No. 60/636,243, filed on Dec. 14, 2004.

(51) Int. Cl. B64B 1/02

(52) U.S. Cl. 244/30

(57) ABSTRACT

Various novel means are provided to neutralize determined if not fanatical attackers, and in most embodiments to proactively prevent harm to most or all innocent bystanders. In one example, a flyable unmanned craft is provided, which is useful for disrupting an armed enemy from shooting friendlies. In another example, a system offering protection to victims of any one or more of terrorism, criminal behavior and disasters is provided. In yet another example, an inflatable protective device is provided, having at least one armored, puncture-resistant or projectile-resistant material or layer facing or presented to a threat which is in turn mounted upon an underlying shock-absorbing member. In a still further example, a system is provided that is capable of target-designating or tagging a potentially or actually harmful person, possibly located among innocent persons or potential victims, for neutralizing or lethal action.

### CROSS-REFERENCE TO RELATED APPLICATION

The present application claims priority from provisional application No. 60/636,243, filed Dec. 14, 2004.

### BACKGROUND OF THE INVENTION

The present invention is directed to dealing with terrorists/attackers and provides various mechanisms for containing a physical threat, neutralizing the terrorist/attacker, and/or protecting innocents. Many of these mechanisms may also be useful in cases of combat and disasters.

Described herein are novel means to neutralize determined if not fanatical terrorists/attackers, and in most embodiments to proactively prevent harm to most or all innocent bystanders. I focus on two depressingly familiar and seemingly intractable scenarios: a) An armed attacker(s) has actual or potential hostages, typically in a confined space such as on an aircraft, bus or train; and b) A shooter(s) or sniper, whose exact or general location is known, needs to be neutralized before a sensitive facility is breached or damaged or before he causes casualties to bystanders or friendly troops. In both cases, I propose solutions that I believe are fundamentally new, utilizing combinations of old and new technologies that clearly can be implemented and are workable and minimizing of what determined aggressors can accomplish.

Additional embodiments are described wherein the physical threat being addressed by the invention may be caused instead by an accident, a crash, or an impending accident or fire possibly unassociated with attackers, and in these the behavior of the inventive devices is seen to offer protection as well.

I typically utilize inflatable protective devices for my various embodiments, so it is first important to review the relevant art in that area. Such art involves inflatable protective devices that remain inflated for extended periods as opposed to virtually instantaneous deflation such as takes place in auto airbags. Such relevant art also involves using materials that are bulletproof and generally utilize armored materials. While there is a fair amount of art relating to the use of armor and bullet-resistant fabrics and materials, I offer the unique protective features of the invention by combining the synergistic benefits of armored materials preferably backed by inflatable members, many of which are also applied in a novel inventive manner to achieve the purpose(s).

Turning now to the relevant art, U.S. Pat. No. 4,782,735 to Mui et al discloses a briefcase-stored inflatable shield for use in defending oneself against incoming gunfire. Readers may be aware that many police departments presently utilize non-inflatable shields for this and related purposes. Important aspects of this reference to keep in mind as I teach my inventive embodiments are as follows: a) This device is carried by and activated by the user and used at the user's location; b) Specific examples of bullet-resistant materials and inflatable materials are not taught; c) It is clearly implied if not taught that the inflatable is primarily made from the bullet-resistant material, yet no gas-impermeable bulletproof material is mentioned or taught (the most widely used bulletproof material (not taught therein) is a fabric which is not gas-impermeable); d) There is no preferred location upon the inflatable whereupon bullet-proofing is concentrated, thus if the entire device is fabricated of heavy bulletproof material, then the overall device will be quite heavy; e) The device is used basically one per person; f) The device offers single-direction protection from projectiles; g) The device must be hand-carried by the user; h) The device has a planar mattress-like shape useable as a shield from projectiles coming from a single general direction, the direction being selected by the user; i) Local consumable gas-bottle inflation is taught, using a gas achieving only inflation; j) If multiple such shields are employed, they do not communicate with one another nor does any given shield communicate with anyone or anything (these are inert devices much as hand tools are; the only intelligence involved is that of the user grasping the device); and finally k) It is taught that the inflatable material and the bulletproof material are the same material, thus the bulletproof material must be quite flexible and impermeable to gas pressure. This is as opposed to, for example, separate inflation materials and bulletproof materials, or flexible inflation materials and semi-rigid or rigid bulletproof materials.

Moving now to a group of related patents, U.S. Pat. No. 5,271,311, U.S. Pat. No. 5,370,035, U.S. Pat. No. 5,413,026, U.S. Pat. No. 5,438,908 and U.S. Pat. No. 5,811,719 all issued to Madden. These are all directed to a removable bulletproof apparatus for vehicles. None of these utilize nor suggest inflatable members and are therefore not relevant.

Moving now to U.S. Pat. No. 6,685,071 to Prather, therein is taught a carrying bag convertible to a self-protection device. Use of inflatable members is not suggested for any purpose, thus the patent is not relevant.

Finally there are three related patent applications, US 2003/192426A1, US 2003/221547A1, and WO03058149A2 all to Peretz. Basically what is described is a bilayer metal and ceramic (or glass) armored laminated plate. The laminated plate(s) are preferably held in the pockets of an unarmored fabric-hanging device, but they may be big enough to be used singly. In any event, what is taught therein has no mention of an inflatable member nor any mention of the armored device having an activation means or control system. The Peretz teaching essentially covers an improved armor material.

Given the above art, the reader will see that only the Mui patent is sufficiently relevant to deserve detailed comparison. Thus, I note in the Mui discussion above commentary items (a)-(k) each can alone delineate Mui as being fundamentally different than my embodiments as those embodiments are explained.

### SUMMARY OF THE INVENTION

In accordance with the various embodiments herein, novel means are provided to neutralize determined if not fanatical attackers, and in most embodiments to proactively prevent harm to most or all innocent bystanders.

In a first embodiment, a flyable unmanned craft is provided, which is useful for one or more disruptive purposes of i) interfering with potential or actual lethal fire coming from an enemy, ii) tracking or locating an enemy, iii) target-designating an enemy, iv) delivering lethal or incapacitating force to an enemy, or v) delivering psychological measures to an enemy. The unmanned craft comprises:
(a) a buoyant or powered-lift airborne craft with a hovering capability which can at least one of be spatially positioned to disruptively block an enemy field-of-view, block an enemy field-of-fire, target-designate an enemy, incapacitate an enemy, or deliver neutralizing psychological measures to an enemy;
(b) the craft having damage tolerance or resistance to at least small-arms enemy projectile impacts in terms of substantially maintaining its airworthiness despite at least some such impacts;
(c) the craft having spatial positioning and/or propulsion means which allow it to substantially maintain or correct the desired position, positions or flight-path despite interfering projectile impacts or wind conditions; and
(d) the craft, whether remotely-guided, self-guided or both, thereby offering a means to usefully disrupt or incapacitate the enemy's ability to inflict harm on friendly forces or persons,
   wherein the enemy is defined as a person at least apparently willing to do or direct harm to friendly persons, forces or strategic facilities, the friendly persons, forces or facilities being anywhere.

In a second embodiment, a system offering protection to victims of any one or more of terrorism, criminal behavior and disasters is provided. The system provides the protection via one or more of i) immobilization of a perpetrator, if any, ii) protective physical immobilization of potential victims of a disaster, iii) protective physical shielding of potential victims of a disaster, iv) physical blockage of dangerous flying projectiles or debris whether coming from a perpetrator or as a consequence of a disaster or v) visual blockage of the perpetrator such that he cannot easily act against victims. The system comprises:
(a) an at least partially confined space in which the protection is to be offered, confined meaning the space has at least two generally opposed surfaces;
(b) at least one inflatable member inflatable into the confined space and toward a generally opposed surface upon a triggering signal or event;
(c) the at least one inflatable member providing at least one of the beneficial immobilization, shielding, blockage or visual disruption;
(d) the at least one inflatable member remaining inflated for a period of seconds to minutes as by continued inflow of inflation media or as by inflow and subsequent substantial sealing of in-flowed media; and
(e) the inflation, as necessary, accompanied by appropriate venting of air in the confined space to avoid over-pressurization of the space that would itself permanently harm the victims directly or indirectly.

In a third embodiment, an inflatable protective device is provided, having at least one armored, puncture-resistant or projectile-resistant material or layer facing or presented to a threat which is in turn mounted upon an underlying shock-absorbing member. The protective device comprises:
(a) an underlying inflatable member capable of absorbing shock and spreading impacting loads situated adjacent or facing the user being protected; and
(b) at least one segment, section, layer or piece of armored or puncture-resistant material overlying or attached to the inflatable member and facing a threat,
   wherein the combination of the overlying armored layer and the underlying inflatable member provides a two-stage protective system of overlying penetration resistance and underlying energy-absorption and impact energy-spreading.

In a fourth embodiment, a system is provided that is capable of target-designating or tagging a potentially or actually harmful person, possibly located among innocent persons or potential victims, for neutralizing or lethal action. The system comprises:
(a) an imaging means allowing for imaging persons including the harmful person or persons; and
(b) a target-designator or tagging means allowing for designation or targeting of an imaged person deemed to be or to potentially be harmful,
   wherein the imaging means providing information useful to the aiming of the target designation or tagging means and the designation or tagging means illuminating the harmful person in a manner preferably invisible to the unaided eye,
   wherein the designation or tagging illumination thereby available to guide the action of lethal or non-lethal force or agents directed at the harmful person, and
   wherein the designation or tagging being directed or aimed by one or both of the systems own intelligence or by a user of the system.

### BRIEF DESCRIPTION OF THE DRAWINGS

To clarify the inventive embodiments, I include four figures as follows:

FIGS. 1a-1d depict the disabling loss of field-of-fire for an enemy or criminal shooter and the protective cover offered to friendly forces by the invention's first embodiment.

FIGS. 2a-2b depict the immobilizing effects on a terrorist and innocent bystanders/passengers as well as the beneficial bullet-shielding effects offered by the invention's second embodiment.

FIGS. 3a-3b depict the protective benefit of an under-vehicle inflatable device of a third embodiment of the invention.

FIG. 4 depicts the discrete target designation of a terrorist by numerous real and fake designation and imaging devices on board a closed-quarters aircraft. Interdiction of the designated terrorist may be undertaken in many known and future ways. The terrorists are preferably discretely rendered as marked-targets despite all their efforts at avoidance. This embodiment may be practiced in unconfined spaces as well.

### DETAILED DESCRIPTION OF THE INVENTION

The following disclosure is directed to four embodiments, which are now described as follows:

### First Embodiment

Let us start with the first embodiment for dealing with shooter(s) or firearm-enabled attackers. Despite firearms having been around for a very long time, I note that there is no real defense against a well-aimed incoming bullet or projectile. Some body armor types can stop some torso-centric rounds and some types of helmets can stop some upper-head rounds. But even in these cases, the wearer receives a substantial, at least temporarily disabling and disorienting impact shock or blow. In any case, even such “protected” troops have exposed unprotected head-parts and limbs. In any case, some carefully aimed or even “lucky” high-power or explosive rounds will always penetrate some such armor. In any case, not everyone will always be wearing such body armor. In short, there is no current way to advance upon or allow exposure to such a shooter or fire without likely being shot at and possibly wounded/killed, particularly if the shooter is shooting from good cover and one does not have good cover, even if one is wearing body armor.

Historically, one may recall schemes wherein it has been suggested that one build a system wherein, for example, one has a laser/radar system that detects incoming bullets as well as their path and point(s) of origin. Such a laser system then helps friendly forces aim (perhaps automatically) defensive fire upon the shooter and/or upon the incoming projectiles.

While I believe that man-portable laser-detection (or radar detection) of gunfire point-of-origin and flight path will certainly be doable in the near decades, this will solve only part of the problem only some of the time. In many practical situations, one frequently already knows where the shooter is, with reasonable accuracy, and the laser information adds nothing unless one is trying to intercept incoming slugs directly (an exceedingly complex task that has yet to be demonstrated). Attempts to fire physical objects to intercept incoming projectiles such as a stream of incoming slugs are probably impractical and cost-prohibitive for many years to come, at least for man-portable systems. In any event, even if such a system could be made, probably based on optical (or radar) detection plus optical laser-shootdown, it could be overwhelmed or at least rendered imperfect with additional decoy projectiles. This situation is similar to that of “Star Wars” ballistic missile defense proposals wherein the optical/optical route is being actively pursued. It has merit, buts it is very, very expensive and cannot avoid being overwhelmed.

Therefore, I propose the following out-of-the-box approach which is the first major embodiment of the invention:

IYFDs or “In-Your-Face” Devices: Simply put, an enemy shooter shooting from a position at a distance from friendly personnel is at least passively neutralized by filling his immediate field-of-view (and field-of-fire) with remotely controlled airborne bullet-proof or bullet-tolerant balloon or airborne devices. For example, such a device could be a Kevlar™ based 10 foot long unmanned RPV remotely flown or “suspended”, perhaps 10 feet in front of the shooter's position and out of his reach. The device cannot be brought down by small arms fire and any impacts can be countered with appropriate spatial readjustments provided by propulsion and inertial-sensing means. Such a craft or device could be field-inflatable and have high-acceleration propulsion that is capable of neutralizing the effects of wind and small-arms high-velocity impacts. I strongly emphasize that given the shooter-localized placement of the inventive device(s), one is able to protect a large area through which friendly troops or personnel can more safely move. As an example, someone shooting from a window on an upper floor of a building could be substantially blocked, and the device could follow the shooter from window to window or floor to floor if necessary. Other desirable features of such a device would cause shooter RPGs (rifle-propelled grenades) or related shoulder-fired missile or mortar rounds to explode or be deflected at his proximate location upon impact with (or perhaps even penetration) of the device. Further, the inventive method may also cause the shooter to seek a different shooting position during or after which time he may be more exposed. In any event, even in the most conservative analysis, the shooter is going to be substantially interfered with or disrupted and coerced to expose him or forced to wait to inevitably be neutralized. Below, I describe additional operative elements that can be installed on such an IYFD including a remote-control weapon. Imagine how distracted a shooter would be if he were faced with a number of obscuring devices, some of which can see him and pick him off via remote or in-vehicle control or intelligence. Furthermore, if the shooter resorts to a heavier weapon, the round explodes in his immediate vicinity, preferably neutralizing himself in the process.

So as a summary description of this first major embodiment, I have a flyable, preferably-unmanned, craft useful for one or more disruptive purposes of i) interfering with potential or actual lethal fire coming from an enemy, ii) tracking or locating an enemy, iii) target-designating an enemy, iv) delivering lethal or incapacitating force to an enemy, or v) delivering psychological measures to an enemy comprising:
(a) a buoyant or powered-lift airborne craft with a hovering capability that can at least one of be spatially positioned to disruptively block an enemy field-of-view, block an enemy field-of-fire, target-designate an enemy, incapacitate an enemy, or deliver neutralizing psychological measures to an enemy;
(b) the craft having damage tolerance or resistance to at least small-arms enemy projectile impacts in terms of substantially maintaining its airworthiness despite at least some such impacts;
(c) the craft having spatial positioning and/or propulsion means that allow it to, preferably automatically, substantially maintain or correct the desired position, positions or flight path despite interfering projectile impacts or wind conditions; and
(d) the craft, whether remotely-guided, self-guided or both, thereby offering a means to usefully disrupt or incapacitate the enemy's ability to inflict harm on friendly forces or persons,
   the enemy being defined as a person at least apparently willing to do or direct harm to friendly persons, forces or strategic facilities, the friendly persons, forces or facilities being anywhere.

A significant capability of this first embodiment is what I shall now define as a hovering capability. By hovering capability is meant that the craft can do at least one of the following:
(a) maintain an airborne spatial position for a period disruptive to the enemy, the position being substantially fixed in space;
(b) maintain a blocking position between the enemy and at least one friendly as one or both of them moves;
(c) maintain positions in the immediate near-field of an enemy regardless of movements of friendly forces, the near-field position being disruptive to the enemy's observation and firing intentions and/or to his desire to retain cover;
(d) follow an enemy from a standoff distance including having the capability to remain substantially stationary if the enemy is stationary;
(e) provide a stable platform for sensors or offensive measures to be directed at the enemy from or with the help of the craft; and
(f) keep its center of gravity in a fixed spatial position but not necessarily keeping its orientation constant.

I have described the craft as preferably unmanned and flyable as well as hoverable. To be more specific, the craft preferably has one or more of the following capabilities:
(a) the craft is at least partially buoyant at at least one point during deployment;
(b) the craft has a lift-providing means;
(c) the craft has one or more aerodynamic control surfaces;
(d) the craft has at least one of a projectile resistant or puncture-sealing feature;
(e) the craft has at least one of a positional, spatial, distance, altitude or inertial sensor;
(f) the craft has a propulsive position or orientation correction or maintenance means;
(g) the craft utilizes gyros and/or accelerometers to detect or maintain a spatial orientation or position;
(h) the craft is remotely controllable at least at one point during its deployment;
(i) the craft is self-controllable at least at one point during its deployment;
(j) the craft is self powered or internally powered at any point;
(k) the craft is powered via an umbilical or other directed or routed external energy source;
(l) the craft includes self-guidance or self-navigation features;
(m) the craft is capable of at least one of climbing, descending, rolling, yawing or pitching about or along one or more craft axes;
(n) the craft utilizes a propulsive thrust directed at least partially vertically to counteract gravity and provide an element of lift; and
(o) the craft utilizes any of optical, laser, video or acoustic sensors to determine at least one distance or orientation useful to an operative function of the craft.

Regarding the tactical or strategic use of the craft, I anticipate one or more of the following preferable uses:
(a) the craft provides at least visual blockage or interference of an enemies field of view or field of fire;
(b) the craft provides blockage or interference of or with enemy fire or enemy target-designators;
(c) the craft supports, suspends or dispenses visual or projectile-blocking screens, sheets or structures;
(d) the craft includes an offensive or defensive lethal or incapacitating weapon of any type;
(e) the craft includes an offensive or defensive gas, spray, aerosol, chemical, irritant, Taser™ or flash grenade;
(f) the craft includes a means of optically, electromagnetically or acoustically finding or tracking an enemy;
(g) the craft includes an automatic algorithm to either follow an enemy or to maintain a blocking position interfering with the enemy's ability to harm friendly forces; and
(h) a craft positioning means takes into account at least one of the position of the enemy or the position of a friendly person to offer useful protection to the friendly or friendlies from the enemy.

Further, it is anticipated that the craft will have one or more of the following assembly, material-makeup or size-attributes:
(a) is at least partially inflated with a gas, vapor or foam;
(b) is at least partially assembled from two or more modules or subsections;
(c) has one or more modular, detachable or exchangeable propulsive means, enemy tracking means, weapons means, navigation means or flight-control means;
(d) is of a size such that when placed in the near-field of an enemy, it substantially blocks his field-of-view or field-of-fire;
(e) is of a size such that upon placement at a spatial position offers coverage to friendly forces, the position or positions being anywhere between the friendly and supposed or known enemy positions and chosen for maximum situational benefit;
(f) the craft has a skin including a substantially gas-impermeable layer;
(g) the craft has a skin including a woven or non-woven substantially bullet-proof or puncture-resistant fabric;
(h) the craft has a skin with one or more armored tiles, plates, layers or coatings;
(i) the craft has a self-sealing skin layer that at least partially seals punctures;
(j) the craft has a fire-resistant skin layer; and
(k) the craft has a vital navigation or propulsion means hidden inside or behind a projectile-resistant skin or housing.

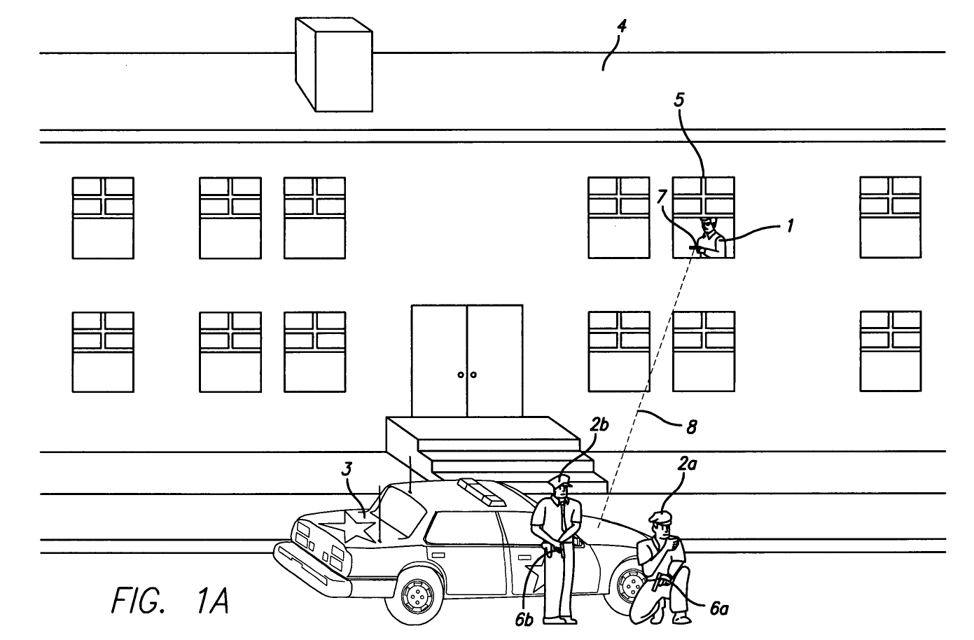

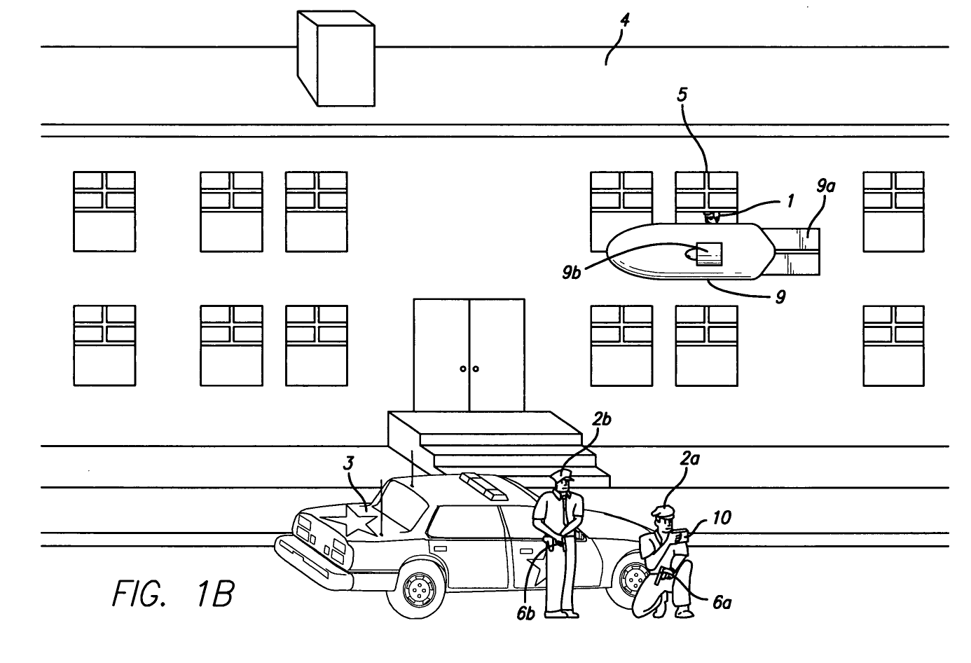

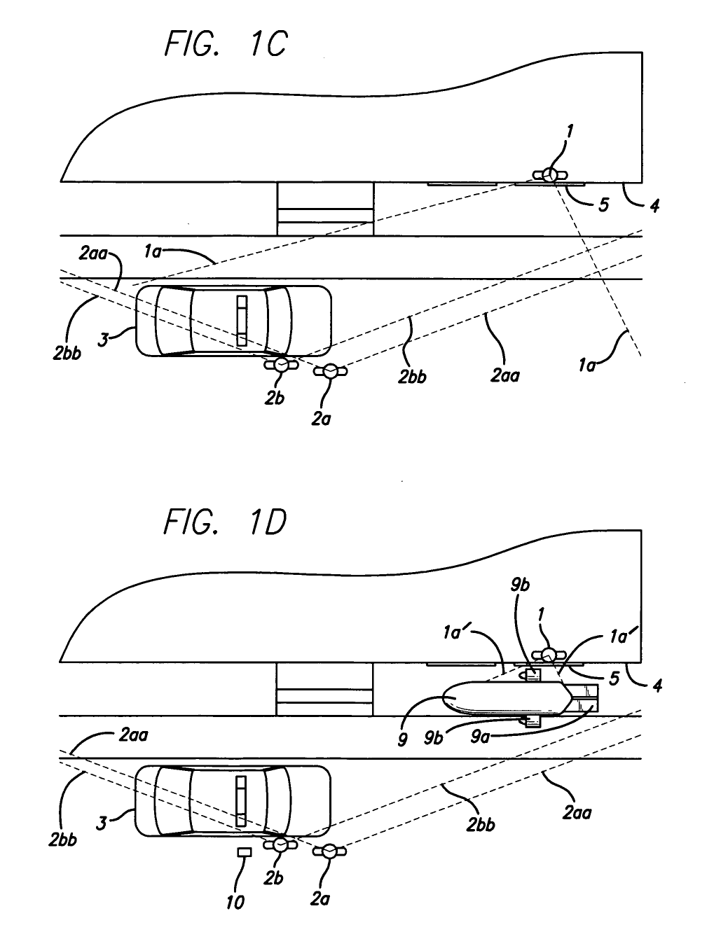

FIG. 1a depicts a potential application-scenario of this first embodiment. Seen therein are two police officers partially ducking behind their police car and a shooter or sniper preparing to fire at them from a second story window above the street and sidewalk. This is a front view looking over the officer's shoulders toward the shooter. Specifically, we see the shooter 1, the two police officers 2a, 2b, the police officer's car 3 behind which they are only partially hidden from the shooter, the building 4 in which the shooter hides and the building window 5 from which the shooter is about to shoot at their exposed body portions. We see that each of the two police officers has a handgun 6a and 6b respectively, directable at and also able to be fired at the shooter 1, that shooter 1 has a firearm 7 generally directed at and ready to shoot at the officers 2a,b, and that dotted line-of-sight 8 represents an unobstructed line of fire and projectile (bullet) path between the officers exposed heads/torsos and the shooter. It should be obvious that the officers 2a, 2b will risk themselves by exposing their bodies in their attempt to neutralize the shooter 1.

Moving now to FIG. 1b, the same scenario front-view is shown, but now with the first inventive embodiment of the invention at work protecting the officers 2a, 2b. Seen hanging in space just in front of the shooter's line of sight but just out of the shooter's reach is my remote controlled blimp device 9. It is depicted as having a length of about 10 feet and a diameter of about 3 feet in this example. Typical blimp-like control surfaces and fan thrusters can be seen. One of the officers holds a control box 10 with which he is directing (or maintaining) the blimp into/in the shooter's line-of-sight or line-of-fire. It should be clear that the blimp could also be controlled by someone else even more protected or distant and that the blocked shooter will have a much greater challenge to shoot at the two officers or at others approaching (or leaving) the building within the blocked field-of-view. Because the projectile-blocking blimp 9 is in the shooter's near-field, it blocks most of the shooter's far-field where the officers are located.

Moving now to FIG. 1c, a schematic-only line-diagram of the top view of the scenario location of FIG. 1a depicts the unhindered lines-of-sight and fields-of-view between the shooter and officers before the inventive blimp or obscuration device 9 is present.

Moving now to FIG. 1d, a schematic similar to that of FIG. 1c is shown; however, in FIG. 1d, I show the inventive obscuration device 9 and the now-obscured shooter's view in the same top view of FIG. 1b. More specifically, the shooter's FIG. 1d field-of-view has virtually no depth given that the blimp 9 is now directly in his face.

In particular, note that officer 2a has lines of sight 2aa in both FIGS. 1c and 1d. Also, officer 2b has lines of sight 2bb in both FIGS. 1c and 1d. However, the shooter in FIG. 1c (no blimp) has lines-of-sight 1a but these are reduced in FIG. 1d to lines-of-sight 1a′ in FIG. 1d. In other words, the shooter's field-of-view is substantially blocked by blimp 9, which is parked in space using control box 10 of FIG. 1b, just out of the shooter's reach.

The key realization of this first embodiment is the ability to construct a preferably bullet-tolerant device that can further controllably choke or extinguish the field-of-fire and/or field-of-view of a shooter. I include in the scope of the invention the case wherein these devices are used with a degree of on-board intelligence or are used from a truly remote location out of sight of the shooter(s). Applications of the devices could be protective, defensive or even offensive. I emphasize that my devices are bullet-tolerant, meaning they are hard to shoot down and resistant to being spatially displaced by impacts. Such tolerance could include one or both of being resistant to puncture as well as being tolerant of puncture, such as by having a multicellular or self-healing buoyancy scheme. I specifically include the filling of these blimp-like devices with foam material wherein the foam provides at least one of some rigidity and some puncture-sealing capability. A rigid foam would likely be in a preassembled full-size blimp, which could still possibly be disassembled into rigid subsections. I note that for a rigid foam-filled blimp, one would unlikely be able to make it fully buoyant with helium or other light gas. Thus, for a foam-filled rigid blimp, one would likely have vertical thrusters which cancel gravity as opposed to (only) buoyant forces which cancel all the gravity. Note also that although at least partially buoyant devices may be employed, I expressly include in the scope of the invention the use of RPVs or craft which have little or no buoyancy and rely, at least in part, on aerodynamics and/or fans/jets/propellers/blades to remain airborne. Thus, the inventive embodiment is unique because it is bullet-tolerant and because it is used by remote control in a novel “in-your-face” remote manner.

A simple descriptive example would be the construction of a small toy blimp such as are frequently seen in closed stadiums at hockey events, but employing a skin of Kevlar™, for example, instead of metallized plastic film alone. The Kevlar™ film can also be metallized if the lower gas leak-rate it offers is required or can alternatively be underlaid or overlaid with a gas barrier film. Such toy blimps are usually about 4-8 feet long and 12-24 inches in diameter and utilize aluminum coated Mylar™ skins and are filled with helium. Typically, they use remotely-controlled fan-motors (usually the type used to cool personal computers) running on batteries. Typically, the controls are those frequently used for remote-control RF-model-airplane flying. There are many sites for information relating to remote-control blimps and planes such as at www.hobbytron.com where blimp kits are available. I modify such blimps, for example, with puncture-tolerance as offered by Kevlar™ fibrous fabric made by Dupont, Inc.

In order to achieve low gas permeability for my inflation gases for the various embodiments, the Kevlar™ film itself can alternatively be coated, impregnated and/or overlaid or underlaid with a polymeric and/or metallic gas barrier as necessary. Such coatings or impregnants could, for example, comprise almost any at least temporarily flowable polymer such as urethane, nylon or silicone. One may also choose to provide gas barrier action as by laminating or simply mechanically backing the Kevlar™ with a conventional gas-barrier film such as metallized Mylar™. Preferably, the Kevlar™ or other puncture-resistant film or fabric goes on the outside exposed surface(s). Another tough film is Lexan™ from General Electric, available in standard form as 0.030 inch sheet and thermoformable. I include in the scope of the invention all inflatable embodiments wherein the bullet-resistance is provided by abutted subpanels of tough material which are held together or mounted upon a second continuous film, such as a gas-barrier metallized continuous film. So what I have is an armor-layer and a gas-barrier layer (for at least partially buoyant versions of the device) and these two layers are typically different materials. The armor layer may be a smooth-looking layer of woven Kevlar™, a continuous film of Lexan™ or even an abutted matrix of ceramic armor tiles.

Typically, the blimp-like device will be 6-12 feet long or so, perhaps having a length/diameter ration of 2:1 to 8:1. It will preferably break down into two or three subsections that are easily transportable in a vehicle or van. Typically, it will incorporate known aerodynamic control surfaces, some of which are controllably deflectable such as a rudder or flaps which are available off-the-shelf in the toy blimps above or as piece parts from hobby stores, for example. Typically, the blimp will be at least partially buoyant and will have directable thrust propulsion, preferably delivered by two or more (dual) electric fan thrusters, which are preferably rotatable on one or more axes to achieve diving and climbing. These are known attributes of toy blimps as well as of real, much larger blimps like the Goodyear™ blimp.

The blimp-like shape is not a requirement of the invention; however, it is a known workable preferred body shape for implementing a partially or fully buoyant craft that is directionally propelled through the air in three dimensions with at least some aid from one or both of overall aerodynamic shape and the addition of control surfaces and thrusters. Within the scope of the invention are very small devices (measured in millimeter or inch dimensions) all the way up to Goodyear-sized blimps or bigger as the need demands. As an extreme example, the device could be a helicopter-like device with no buoyancy gas, just lifting/propulsion blade means. Such unarmored remote control helicopters are also available at good hobby shops. My embodiment thereof again covers and protects the craft with bullet-resistant or bullet-tolerant materials. Preferably, again, my device is large enough to provide visual and/or projectile obscuration and thus would more likely be larger than such toys typically are, that is typically 5-10 feet long or so in my embodiments. It will be noted in the figures that I depict thruster fan motors on the blimp 9. One may alternatively choose to incorporate these inside the protected body of the craft in combination with ducts (not shown) or may cover them with other dedicated bullet-resistant materials and leave them as external parts (shown).

A particularly attractive feature of making such an inventive device is that the cost of the RF or wireless links and any sensing and imaging means incorporated therein are plunging in cost due to pre-existing consumer markets for such components.

I explicitly note that although one such device may be employed, one may also employ multiple such devices directed at one or more enemy individuals or troops. In the case of multiple devices, the devices may be beneficially arranged to fly in unison or in particularly beneficial formations. They may also be arranged to operate on different target individuals, stay out of each other's way, loiter, follow individuals, or automatically maintain a designated spatial position. The craft may easily include inertial and other navigational sensors such as accelerometers, gyroscopes, distance sensors, altimeters and tilt-meters.

I note that in the preferred embodiment, the craft 9 flies entirely free of any physical connection to the ground. However, I anticipate some applications wherein a physical umbilical cable may remain attached, that cable being preferably armored, highly flexible, and of small diameter. Such a cable could contain, for example, power lines, signal lines, video and audio connections, means to provide and/or service buoyancy means such as a buoyancy gas source, sources of propellant for thrusting, pneumatic or hydraulic means in support of actuation or on-board weaponry or sensors, or even pathways to deliver obscuring smoke and/or knockout gas.

Note that my craft is tolerant of enemy fire. This can mean that it repels bullet penetration as for an armor-like coating such as Kevlar™, that it seals or heals punctures such as by the flow of a flowable sealant which quickly plugs any hole as has been used for automobile tires, that it has redundant propulsion, steering or navigation means, and/or that it can quickly reposition itself after feeling the impact of a bullet. In any event, my “tolerant” craft is at least less-easily shot down than a conventional toy blimp, even after being hit. It may also, for example, have multiple isolated buoyancy cells in its body, perhaps dozens if not hundreds. In the case of vertical thrusters which instead or in addition offer lift, the craft may be designed with redundant thrusters or damage-tolerant thrusters for example.

In the preferred case, the craft is at least partially buoyant and is stored in an uninflated, more compact form. Inflation preferably causes at least a portion of the craft to take its flyable shape. The inflatable craft 9 may or may not utilize a stiffening skeleton as some real blimps do. Any such skeleton can likely be provided in a collapsible or foldable form with the compacted armored and gas-sealant skin layers preattached but folded to be compact. Propulsion, sensor, and weaponry means may be chosen to be attachable as add-on modules, thereby allowing for field-flexibility in their choice and replacement. These may also be preattached to the compacted uninflated craft.

I specifically note that in a non-buoyant craft, one would not likely utilize inflation with a buoyant gas. The craft might even be delivered in its full-size (not compacted) configuration as in a closed trailer. One might also choose to air-inflate, for example, a craft simply to attain the inflated rigid full size and shape, even if the inflation gas offers no significant buoyancy effect. So it should be clear to the reader that in one embodiment, all lift for the craft is provided by non-buoyancy means, such as by thrusters, jets or rotors. However, if an umbilical-free craft is to be provided, then power for the thrusters and control surfaces would have to come from an on-board source. Given that, a fully buoyant craft or nearly-buoyant craft (with thrusters off) would be light and would therefore require a more modest on-board power source.

Any umbilical or cable attached to the craft (none shown) may also or instead serve as an anchor such that the craft can maintain a position like an anchored ship, for example. Position maintenance may also be achieved as by inertial sensors and responsive propulsive events. Positional and/or orientation sensors can even be provided remotely as by the use of laser sensors if they are not integrated in the craft itself.

I remind the reader that the Maui reference, discussed above, does not teach my user-remote and remote-controlled application of a communicative if not intelligent protective device, does not teach the device having any intelligence or control features, does not teach an airborne-capable device, does not teach how to make a material such as Kevlar™ gas-impermeable, does not teach an aerodynamic design, and does not teach a device which optionally has on-board sensors if not weapons. The use of the device at or near the threats location uniquely chokes-off almost the entire field of view of the threat. Thus, even a passive blimp of the invention can obscure the enemy's view and line-of-fire such that friendly forces can deal with him on their terms. The prior art also does not teach the attractive scheme of using an underlayer of inflatable elastomeric material overlaid with an external layer of armored fabric or plates.

It should now be apparent in this first inventive embodiment that one could also have the blimp or craft hanging a sheet of Kevlar™ or other at least visually obscuring film or fabric, just as it would hang an umbilical cable. Assuming this is a thin opaque polymeric sheet, it should be obvious that its size can be considerable, thus further blocking the fields-of-view and/or lines-of-fire. A 10 foot long, 3 foot diameter blimp could easily support a hanging 10 foot long and 10 foot tall square visually opaque sheet. Such a sheet could be a few-mil thick, opaque, lightweight, disposable polymeric film (perhaps with a few small weights on its bottom edge). For such a disposable film, a few bullet holes (assuming it is visually blocking only and not bulletproof) would not degrade the beneficial visual-blocking effect very much.

In the case of using an umbilical cord, such as for electrical power or sensors, I expressly include the idea of multiple separate redundant umbilicals such that at least one can afford to be damaged by flying projectiles. Such a redundant system might, particularly in the case of passing signals, intelligently switch to the next available good umbilical upon a prior-one being compromised for any reason. If these are of small diameter and redundant, the shooter is unlikely to expend all of his ammunition trying to cut them all, and success in that is unlikely.

I note that within the scope of the invention are craft 9 which have sensors which allow them to maintain a spatial position automatically, such as by using inertial sensors or using sensors which detect adjacent of viewable surfaces such as walls, floors or the ground. Acoustic and optical sensors are widely available to perform such duties.

Further, the craft may be arranged to follow a suspect and/or dispense a neutralization gas or projectile toward or upon the enemy or foe.

So to continue the list of preferred features which may be used alone or together, I have a craft which has or utilizes one or more of:
(a) a wired or wireless electromagnetic or optical communication link between an operator of the craft and the craft, regardless of the location of the operator;
(b) an on-site craft operator is present;
(c) a remotely situated craft operator is employed;
(d) a craft operator directs lethal or non-lethal force means or psychological measures emanating from the craft upon or at the enemy;
(e) the craft supports a means to communicate with an enemy or vice-versa;
(f) the craft has at its disposal electronic or software-based means of determining, arriving at, or maintaining a spatial position or positions;
(g) the craft has at its disposal electronic or software means for directing or activating lethal or non-lethal fire, interdiction means, neutralization means or psychological countermeasures;
(h) the craft has an ability to fly a predetermined path or trajectory which is either predetermined or is determined with knowledge of an enemy or friendly position, action or intention;
(i) the craft has an ability to inform a controller that it has spotted or located an enemy or enemy hiding location;
(j) the craft is flown, parked or hovered in the near-field of an enemy to substantially interfere with his ability to one or more of see, fire-at or target-designate friendly forces;
(k) the craft is flown through, parked in or hovered in a position, positions or a trajectory which offer protective blocking cover for friendly forces;
(l) the craft, being placed in an enemy's near-field, causes an enemy explosive projectile to detonate in the near-field of the enemy;
(m) the craft is equipped with any of redundant navigation, propulsion, armoring or flying means to accommodate some amount of damage without mission failure;
(n) the craft utilizes any of rockets, turbines, jets, propellers, rotating blades, fans or lighter-than-air gases for any laterally or vertically propulsive or aerial suspension purpose;
(o) the craft offers protective cover to friendly forces from incoming enemy fire;
(p) a craft propulsion means offers both lift and lateral propulsive thrust, whether simultaneously or sequentially;
(q) the craft has at least one aerodynamic shaped surface or member, whether manipulatable or not;
(r) the craft has at least one aerodynamic control surface that is manipulatable;
(s) the craft has at least one directable or fixedly directed thruster, rocket, jet, rotor, propeller, blade or propulsion means providing any of lateral or vertical thrust;
(t) the craft is between 5 feet and 20 feet long, more preferably between 8 and 16 feet long;
(u) the craft is longer than its average width, height or diameter;
(v) the craft includes two or more isolated buoyancy chambers or volumes, thereby offering a redundancy to its buoyant forces, if any;
(w) the craft has an on-board target designator for directing weaponry, which weaponry may or may not be situated on or in the craft itself;
(x) the craft has the general shape of a balloon, dirigible, blimp, wing, cylinder, sphere or airplane;
(y) the craft operates in synchrony or in cooperation with at least one other such craft;
(z) the craft has at least one tether, umbilical or cable, which at least one of provides in at least one direction power, fuel, data transmission, physical anchorage, a buoyancy gas, lethal or non-lethal substances such as knockout or teargas, or a redundant service to the craft;
(aa) the craft has a controller within at least occasional visual or video sight of the craft;
(ab) a craft controller resides within communication-link range of the craft, the link possibly being miles to thousands of miles long;
(ac) a craft controller is in an aircraft flying overhead or nearby;
(ad) an artificial intelligence means on-board or off-board the craft contributes to controlled flight of the craft;
(ae) a combination of human inputs and software algorithms or programs resident on-board or off-board the craft contribute to flight of the craft; and
(af) software or algorithms adaptive to at least one aspect of enemy or friendly behavior or positioning are employed, the software or algorithms being resident on-board or off-board the craft.

So it can be seen that the craft may be spatially employed in the enemy-near-field obscuring manner or at any other position that offers one or more of the many disruptive measures. One can anticipate such craft surrounding moving friendly forces to provide them cover. In doing this mission, they may utilize software and algorithms to retain optimal positioning between potential incoming fire and the friendly troops. I note in particular that groups of such craft may communicate with each other such that they move together and offer friendlies a continuum of coverage in an optimal manner using the fewest possible craft. I also emphasize that particularly in the case of the craft utilizing electric propulsion thrusters such as fans, the craft will be very quiet and will be able to surprise an enemy or hear an enemy before he can hide from the craft or become silent. I anticipate that such inventive craft can serve foot-soldiers as lookouts or as a point-man, providing some notice of the presence or intention of the enemy. My inventive craft may even be used in an offensive mode wherein the user or controller depends on his judgment or on the judgment of craft software at to when to deliver disabling or lethal fire.

An additional neutralization weapon that may be included in the craft is an optical laser whose purpose is to at least temporarily blind the enemy such that he cannot utilize his visually-aimed weaponry. Such an enemy, if not fanatical, may be likely to surrender upon realizing that he is defenseless.

### Second Embodiment

I now move to the even nastier problem of neutralizing terrorists in closed quarters, or at least minimizing the mayhem they can cause. One of the worst situations is that wherein a terrorist or hijacker has hostages on an airplane or in confined quarters and he threatens to kill them one by one unless demands are met. There have been many well-intentioned suggestions over recent years how one might deal with such threats. I will mention some of these below and also mention with each, in my opinion, what significant problems each leaves unsolved or newly introduces:

Knock-Out Gas/Tear Gas: No gas can be delivered to an entire aircraft passenger compartment and take effect in anything less than 10 seconds and more likely, assuming the shooters hold their breath or cover their mouths, 20-40 or more seconds. This is obviously enough time to kill most or all of the hostages serially. The recent incident in a Moscow theatre wherein knockout gas was delivered by friendly forces demonstrates the difficulties. Not only were many hostages shot and otherwise killed by the perpetrators during “rescue” gassing, but the rescue gas itself unintentionally killed many hostages due to poor dosage control. If rescue gassing means were standardized (and known to be present), one could defeat them with breathing apparatus, provided that apparatus could be smuggled on-board or into the facility. Another downside of rescue gases is that rescuers may require breathing-apparatus that, at a minimum, obscures vision and affects physical motion and dexterity. Gas only works perfectly if the unequipped terrorist is alone in a confined isolated space (unlikely). I will discuss a novel application of knock-out or rescue gas in association with my second embodiment below that works substantially better.

Smoke: It is not obvious to this inventor that filling a passenger compartment with smoke or other obscuration cloud is going to stop the fanatic terrorist from firing his clips regardless of whom he can or cannot see. Furthermore, while smoke is present, rescue personnel are also somewhat limited in what they can see, and infrared imaging devices to see through smoke are currently bulky and motion-limiting and they slow reaction-times. Smoke might have marginal value wherein success is defined by saving many hostages as opposed to all or most hostages. However, I believe that it degrades advantages for all parties unless the rescuers can technologically see through it without hindrance. Even then, what keeps the terrorist from firing in random directions?

Sky Marshals: I believe this is a useful approach; however, a recent publicized survey demonstrates that something like 90% of passengers know which passengers are the sky marshals due to their dress regimen and boarding protocol. Therefore, terrorists also likely know who they are and they can therefore target the sky-marshals as discussed in the above publicized survey commentary. I hope the appropriate agencies will, in the future, allow these dedicated and desirable marshals to dress like normal travelers and be at least somewhat anonymous. The current situation can only be characterized as institutionally-stupid, but well-intentioned. Even anonymous sky marshals are only a deterrent and in some cases will be neutralized even if present. Despite this, sky marshals are clearly at least a deterrent, even when they are not anonymous, much more so when they are anonymous.

Dummy Concussion and Flash Grenades: Again, the inventor does not see what keeps the terrorist from firing his clips during the ten or twenty seconds that it takes to make ingress by the rescuers. Rapid-fire weapons can shoot dozens of slugs in a very short time of a few seconds. Significant casualties can still be expected. A terrorist is likely to shoot even if his aim or vision is impaired.

Note that in the above commentaries, I focused on the terrorist's automatic weapons. In reality, however, terrorist bombs are the most severe challenge possible. I will explain below how, even in that seemingly hopeless situation, the second embodiment of the invention may still stop, or at least minimize, the mayhem in such apparently hopeless cases.

Accordingly, I suggest the following inventive out-of-the-box approach, which is the second major embodiment of the invention:

Bulletproof or Bullet-Tolerant Inflatable Immobilizers (BIIs):

Imagine being in a passenger aircraft with a terrorist ready to kill one or more passengers. Imagine, suddenly, that “explosively” or rapidly inflated “airbags” virtually instantly surround and very forcefully pin every person in the thus-protected space. Everyone would be shoved, with considerable force, to their seat or floor surfaces, but with minimal or at least not life-threatening injury. The terrorist would immediately lose his field-of-fire as well as his view of virtually all the passengers. Even if he fired, assuming he could raise his weapon, the multiple puncture-resistant armored balloons would deflect, slow or stop most or all of his slugs. The inflatable bags would also effectively allow for safe ingress of rescuers. The inflatable bags, or related venting means, could also emit knockout gas, which has plenty of time to take effect while people are pinned.

A passenger aircraft body is typically designed to sustain several pounds per square inch of pressure-difference and pressure-change across its skin thickness from inside to outside. Within the allowable pressure delta across the fuselage skin, one could inflate such bags on the ground or in the air. The inflation could be coordinated with appropriate (possibly pseudo-explosive) decompression or venting of the cabin such that the net intra-bag pressure does not peak much above 14.7 psi (or normally maintained at-altitude pressure which may be somewhat less) despite the sudden bag expansions. Such cabin decompression would also act as a vent for the cabin air being otherwise forcefully displaced or compressed. Note that the “decompression” could be done in a manner wherein vented cabin air (whose outward flow normally reduces cabin pressure) is negated by the incoming pressurization of the inflatable devices, such that the overall pressure experienced by passengers between and under such inflatable balloons is not appreciably different than normal cabin pressure, and certainly at least not for long.

The inventive inflatable bags do not necessarily have to fill the entire passenger space nor do they all necessarily have to be inflated or inflated during an incident. One can easily picture a scenario wherein the passenger cabin is substantially separated into several isolated sections by banks of inflating bags, thereby at least protecting most of the passengers. The inventive inflatable bags may also protect the fuselage from bullet penetration and at least be self-sealing for any modest-size undesirable out gassing holes made in the fuselage.

I note that existing automobile crash-protection airbags must be explosively inflated in a few milliseconds because of the extremely limited time available before the passenger/driver otherwise hits the steering wheel or dashboard. In a room, such as a nuclear power plant control room, one would probably desire to inflate the inventive bags somewhat more slowly for two reasons. First, displaced air is preferably at least partly vented, and I include in the scope of the invention applications wherein such venting is provided for this purpose. Such venting may be provided by the confined-space's connecting corridors, aisles, ventilator shafts, etc., or may be provided by vents or responsive designed for this specific purpose. One would prefer not to shatter all the windows by either managing the peak pressure pulse (pressure outside bag(s)) or providing for impact-resistant glazing such as Lexan™, which could be designed to pop-out as opposed to break (a form of venting) if necessary. In any event, one can easily imagine a useful system that had 100% inflation occur over a quarter to half-second, for example. The second reason is that we do not want to break someone's neck and would like individuals to have limited time to instinctively brace for their fall or brace for their being pinned by the cushion-like yet forceful inflatable.

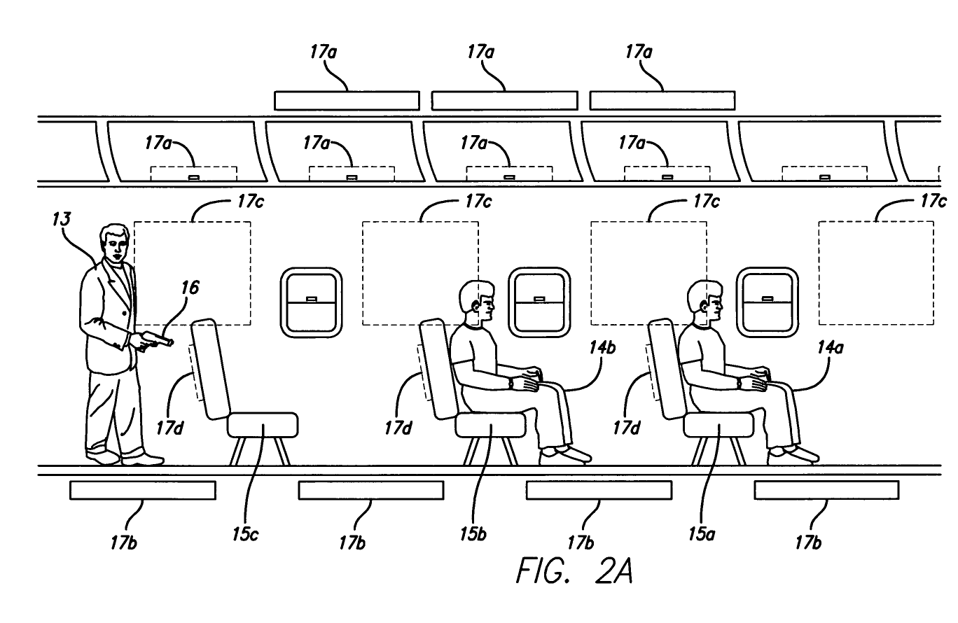

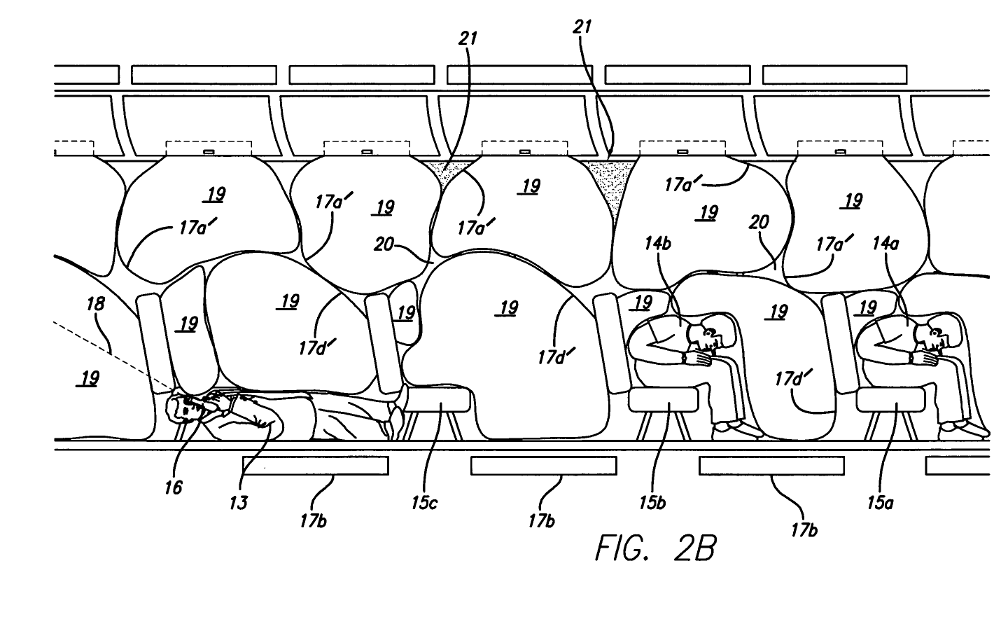

FIG. 2a depicts a sectional view of an aircraft passenger cabin. Three seats can be seen, seat 15c where a terrorist 13 is standing in the aisle, seat 15a where a first of many passengers 14a sits, and seat 15b where a second of many passengers 14b sits. The terrorist 13 is shown brandishing a firearm 16. Numerous stowed and uninflated inflatable bags of this embodiment are depicted. Stowed bags 17a are in the ceiling over the aisle and the seat positions, 17b in the floor, 17c in the walls and 17d in the seats.

Moving now to FIG. 2b, note that a subset of available inflatables, namely 17a,d (now designated 17a′,d′ as-inflated), have been inflated and the passengers 14a, 14b and terrorist 13 are pinned in crouched or prone positions by them. Note that the terrorist's arm and his gun 13 are in an unfavorable shooting position. Note further that bullet path 18 is the theoretical path a bullet from the terrorist's gun would take if he could pull the trigger, but that that path intercepts several armored balloon 17a,d surfaces, which will stop it and/or deflect it. I depict the inflated interiors of the bags as items 19 and the various tight spaces between inflated bags (intrabag spaces) as spaces 20. Note that I schematically depict a knock-out gas 21 being delivered to the intrabag spaces 20 either directly of via purposeful leakage from the bags 17a,d or bag interiors 19 or from independent vents (not shown).

Technologies for filling balloons or bags are widely known and includes auto airbag pyrotechnic means, pressurized gas means, gas-pumping means, inflation by external-suction (as by reducing cabin pressure), inflation by foams or liquids, etc. My preferred filler is air or pyrotechnically derived gas byproducts, perhaps with knockout gas added at some point. The scope of the invention covers any filling material, including filling materials that revert from flowable to unflowable or at least to partly-rigid after or even during bag inflation. Such rigidity, perhaps of a hardening foam, could provide very substantial pinning forces and projectile protection. The bags preferably, like the earlier blimp embodiments, incorporate armor layers such as Kevlar™ fabric overlying a gas-impermeable polymeric balloon material such as metallized Mylar™ or elastomer. I include in the scope of the invention all manner of pressure vs. time filling/venting schemes. A preferred scheme is that which at least allows for inflation to a sufficiently high pinning-pressure (e.g., in the approximate range from sub1psi-15 psi, for example) within a time frame of less than about 100-500 milliseconds.

I include in the inventive scope improvements to assure that persons are not suffocated, such as providing the bags with a grooved surface-topography or having the bags emit a net flow of breathable air from within the bag(s) itself (leaky bags). Of course, breathable air may also be provided to the intrabag regions directly, if desired, in any other manner desired. Bags which leak gas of any type for any purpose may require means to apply a prolonged pressurized source of such gas over a period of minutes, at least. Bottled gas or pumped gas (perhaps from the ambient or atmosphere outside) can serve this purpose nicely.

I expressly include in the scope of the invention systems that are preinstalled as well as systems that are delivered to an incident site. For example, my expanding balloon or bag systems could be delivered as a projectile(s) or by a crawling robot, perhaps trailing an inflation umbilical(s). It could be fired through a window or even a wall or fuselage. It could optionally deliver knockout gas or be delivered with knockout gas. Included in the scope of the invention is making one or more inflatable devices with vents for such gases to be delivered around the balloon or inflating bag device. The inflatable bag or balloon may also be arranged to have sticky or Velcro™-like surfaces that inhibit crawling or sliding under the balloons, or even causes the balloons to stick to people and/or other balloons. I define “inflation” to mean volumetric expansion of my balloon or bag by a net pressure differential from inside to outside the bag. That pressure differential may be applied by manipulating one or both of inside-bag pressure and outside (cabin or other ambient) pressure with a flowable media, preferably a gas or vapor but conceivably could even be a liquid or foam.

I note again that my inflatable devices, depending on application, may have one or more interior membranes or barriers as for an inflatable multicellular Kevlar™ protected bag. Such a bag has the familiar armored Kevlar™ outer element and a typically underlying gas-barrier element, typically provided as separate films or materials as discussed for my earlier remote-control blimp embodiment. Such an interior inflatable balloon or bladder could be comprised of multiple independent gas cells, sub-balloons or bladders. In any event, I preferably have an armor layer or layers working together with a separate typically underlying gas-barrier layer in many cases.

For any of the inventive embodiments of the invention that involve inflation, I specifically recommend the use of miniature high-pressure gas cylinders such as those manufactured by Leland Limited Inc. of Plainfield, N.J., which are useable for filling my remote-control airborne obscuration devices (first embodiment) with helium, for example. Somewhat larger cylinders such as those available from Air Products And Chemicals Inc. of Allentown, Pa. would be useful for the inflatable restraint embodiments (second embodiment). In any case, one may alternatively choose to fill inflatables in any desired manner including by using gas pumps and pyrotechnic gas-generators, for instance. An advantage of bottled gases is that they are self-contained and can have any composition, and are safe and inexpensive. One can also control flow vs. time if and as desired.

Included in the scope of this second embodiment is any of making the bags opaque to block the terrorists vision, providing controls such that approved or friendly person(s) can trigger one or more bags, perhaps in a predetermined area, and adjusting inflation pressures and rates as a function of application factors such as cabin-pressure, venting capability (whose function may be co-managed by the bag system), bag size, and bag location. Controls or means may also be provided so that approved persons can deflate one or more bags in-part or in-full. Also included in the scope of the invention is making the bags and/or their inflation material flame-retardant, fire-resistant or non-flammable.

I now note that the inflated pinning bags of this second embodiment could be quite helpful during a fire or crash. For example, if an aircraft is going to crash, whether by terrorist or accident, one could deploy bags which achieve one or more of the following benefits: a) pins passengers preventing or minimizing bodily injury due to impact, b) protects passengers from fire and flying fuel aerosol (fireproof bags), c) provides passengers breathable air in the intrabag spaces, forcing smoke and fire away, and d) prevents injury from flying debris (puncture-resistant bags).

I also note that in the case of a terrorist bomb being exploded, inflated armored bags can substantially reduce the injuries to those near the blast. In particular, peak-pressures are diluted more quickly and flying shrapnel and flames are constrained. The same can be said of peak pressures that would otherwise rupture fuselage members or a nearby fuel tank. In the case where it is expected that a harmful person will detonate a bomb no matter what negotiators do or say, it may be wise to inflate the system before any such explosion, particularly if the plane is on the ground or the confined space is in a ground-based facility that has been invaded or taken over. There is a some chance the terrorist will not be able to detonate his bomb and if he does manage to do so, the system will provide some degree of protection. These clearly are horrible and imperfect tradeoffs to have to make forced by the terrorist; however, they offer some choice whereas the terrorist offers none. What I merely hope to offer here is another possible choice, not a recommended procedure, as that is always best determined by those who are at the site of the incident and know the most about the options, probabilities and psychologies.

Finally, in the case of a missile or rocket being fired and hitting a passenger aircraft, one could inflate the system and get the plane on the ground before flames consume it. Unless the plane is rendered unflyable, the system disclosed herein would help. Even if the plane glides to a crash landing after a missile hit, the system will help with respect to slowing fire and protecting occupants from impact and flying debris Within the scope of this embodiment is the use of inflatable systems such as these by persons in rooms or buildings wherein they are inflated to protect the persons against threats such as fire, smoke, terrorist attack or earthquake damage. I expressly note that a room with an inflated bag in it will help the building remain standing if its structure is being shaken or compromised. Further, occupants may prolong their survival if they are enveloped by a cushioning bag with is fireproof, puncture resistant and capable of delivering breathable air while repelling smoke.

So, summarizing this second embodiment in terms of its required and optional features, I disclose a system offering protection to victims of any one or more of terrorism, criminal behavior, and disasters, the system providing the protection via one or more of i) immobilization of a perpetrator, if any, ii) protective physical immobilization of potential victims of a disaster, iii) protective physical shielding of potential victims of a disaster, iv) physical blockage of dangerous flying projectiles or debris whether coming from a perpetrator or as a consequence of a disaster, and v) visual blockage of the perpetrator such that he cannot easily act against victims. The system comprises:
(a) an at least partially confined space in which the protection is to be offered, confined, meaning that the space has at least two generally opposed surfaces of an inanimate or animate nature;
(b) at least one inflatable member inflatable into the confined space and toward a generally opposed surface upon a triggering signal or event;
(c) the at least one inflatable member providing at least one of beneficial immobilization, shielding, blockage, and visual disruption;
(d) the at least one inflatable member remaining inflated for a period of seconds to minutes as by continued inflow of inflation media or as by inflow and subsequent substantial sealing of in-flowed media; and
(e) the inflation, as necessary, accompanied by appropriate venting of air in the confined space to avoid over pressurization of the space that would itself permanently harm the victims directly or indirectly.

By way of optional features for this second embodiment, the system may, for example, have one or more of the following:
(a) two or more inflatable members being employable in temporal or physical cooperation with each other;
(b) one or more inflatable members forcing or holding a perpetrator into or in a position from which he can do little or no harm;
(c) one or more inflatable members blocking a bullet, projectile or bomb blast from harming or killing at least one potential victim;
(d) one or more inflatable members beneficially pinning and protecting potential victims from being thrown about during an impact, structure collapse or structure disintegration;
(e) one or more inflatable members isolating a perpetrator from his potential victims in terms of his reach, his view, his gunfire or his explosive blast potential;
(f) one or more inflatable members being inflated in a closed or confined space which is vented to allow the inflation without dangerous overpressure;
(g) one or more inflatable members being inflated on or in an aircraft, ship, train, taxi, bus, automobile or any other vehicle; and
(h) one or more inflatable members pinning or clamping a perpetrator or victim against any surface in or defined by the confined space, bodies within the space, or between two or more inflatables.

The system may also utilize, have or allow for one or more of the following:
(a) the as-inflated period provides time for rescuers to intervene with lessened danger to themselves or lessened danger to potential innocent victims;
(b) the actual time to substantially fully inflate an inflatable is between 50 milliseconds and 2000 milliseconds; and
(c) an inflation triggering signal or triggering event is provided by any one or more of: i) an activated alarm, ii) a person observing potentially criminal behavior or disaster in the making, iii) a pilot or crew member of a craft, iv) a gunshot, explosion or impact, v) a detonation of any type, vi) a warning regarding an impending impact of the craft in which potential victims are riding, vii) a warning regarding the impending arrival of an earthquake, fire, tornado or other dangerous event, and viii) a crash-detection or crash-warning device.

Further, the system may also utilize, have or allow for one or more of the following:
(a) an inflatable member is puncture resistant or fire-resistant;
(b) an inflatable member which emits, vents or leaks either or both of breathing gas, knockout gas or a sedative gas or vapor;
(c) an inflatable member which prevents flying burning fuel from coating passengers;
(d) one or more inflatable members which offer blast protection to one or more potential victims;
(e) two or more inflating or inflated inflatables that physically clamp, pin or squeeze a potential victim or a perpetrator in the interfaces of the inflatables or between one or more inflatables and a wall, floor, ceiling, bulkhead or furniture item of the confined space;
(f) one or more inflatable members being inflated from or out of one or more of a ceiling, wall, floor, bulkhead or item of furniture in the confined space; and
(g) one or more inflatable members being delivered or fired into the confined space in an uninflated condition and then inflated, this approach avoiding storage of at least some uninflated members in the space itself.

Regarding inflation itself, the inflatable strategy, and inflatable materials themselves, the system may optionally have one or more of the following features:
(a) an inflatable is filled with a flowed gas, foam or vapor;
(b) an inflatable is filled with a one-time pyrotechnic gas or vapor-producing device;
(c) an inflatable is filled with gas or vapor by the chemical reaction of constituents which are mixed;
(d) an inflatable is filled over a total period of between 50 and 2000 milliseconds total fill-time;
(e) an inflatable is filled no faster than 100 milliseconds total fill-time period;
(f) an inflatable is filled with a breathable gas or vapor mixture which, at least in part, is leaked or vented into the intra-inflatable spaces;
(g) an inflatable is filled, at least in part, with a gas, vapor or aerosol used to render persons in the inflated volume or region unconscious, passive or at least minimally resistant or sedated;
(h) an inflatable inhibits sliding motion of a person or of another inflatable across an inflated inflatable surface;
(i) a subset of inflatables is inflated based on the location of a known or anticipated threat within, entering or leaving the confined space;
(j) rescuers can deflate one or more inflatables on demand;
(k) inflatables remain inflated until a danger has passed;
(l) inflatables are optically opaque;
(m) inflatables are inflated, at least in part, by the sucking action of a vented or reduced pressure confined space;
(n) inflatables have custom shapes optimized for their location and interaction with adjacent or opposed inflatables, walls, ceilings, floors, bulkheads, furniture items or persons;
(o) an inflatable is inflated with a foam or other hardening filler material offering some rigidity to the inflated inflatable at least after a short period;
(p) two or more inflatables are inflated from a common inflation source;
(q) two or more inflatables are inflated from two or more different inflation sources;
(r) two or more inflatables are triggered by a single trigger event;
(s) two or more inflatables are triggered by two or more trigger events;
(t) an inflatable is fire resistant or fire retardant;
(u) an inflatable is tear resistant or puncture resistant;
(v) an inflatable is bullet proof or bullet resistant;
(w) an inflatable, when inflated, cannot be easily moved by an inflatable-pinned or clamped individual;
(x) an inflatable has a high burst pressure;
(y) an inflatable has a controlled leak rate into the confined space;
(z) an inflatable is substantially sealed from deflating after inflation; and
(aa) an inflatable has more than one layer, such as a gas sealing layer and an overlying puncture-resistant layer

### Third Embodiment

The third embodiment is directed to bilayer (or multilayer) armor/gas inflatables. These are devices not unlike those of the second embodiment, but they are instead designed to allow an aspect of mobility or freedom-of-installation while still offering protection. In particular, I am talking about inflatables with an armored layer such as Kevlar™ or impact-resistant tiles of ceramic or Lexan™, for example. More specifically, I prefer an inflatable that presents to the threat or threat direction a protected and preferably impenetrable armored surface. Thus, these third embodiment devices may be armored on only one surface, namely, that which is exposed to the threat. These devices may also not require compact storage in the uninflated condition as preferably do the second embodiment devices. These third embodiment devices also typically will not be pinning persons, friendly or otherwise.

I define “multilayer” as follows: two or more materials, at least one having user-protective behavior and at-least one having at-least some impermeability to a (typically gaseous or liquid) filler medium, the two or more materials being layered or otherwise intermixed with each other in any manner such that some protection and some impermeability is simultaneously offered to the user.

A good example of this third embodiment is a military vehicle that needs to be protected from roadside bombs detonating beneath it or adjacent to it. Specifically, I have a mattress-shaped inflatable mounted to the bottom and/or lower-edges of the vehicle. This mattress-like inflatable essentially comprises an armor-faced mattress with the armored face facing the road surface. Ideally, even in the inflated condition, there is enough clearance that the vehicle can roll normally. In a second preferred approach, there is zero net ground clearance as-inflated and the armored surface actually touches or is dragged along the ground as the vehicle moves. Note that in the case of the driver or user inflating the “mattress”, the gas-impermeable or gas-pressurized portions of the inflatable will push away or drop the armored surface toward the road surface, thereby displacing the armored surface from the bottom of the vehicle. It is thought to be highly advantageous that any explosion and or shrapnel in the roadway will have its peak-pressure and shrapnel suppressed both by the armored layer and the fact that the armored layer is backed by a gas-filled spacer or inflated space which acts like a cushion. Preferably, the inflatable of this third embodiment is filled with air or a gas, but a liquid or foam may also be utilized. Also possible is the case wherein “filling” the inflatable simply means that the inflatable volume is at ambient pressure and the weight of the armor layer pulls or sucks the ambient air into the inflatable such that it is expanded, but really essentially at ambient pressure inside. Thus, I include in the scope of this embodiment “inflation” to also mean “in an expanded state” whether that be by positive pressure, gravity, or even being forced open mechanically, such as by springs, spring-like materials or even external suction.

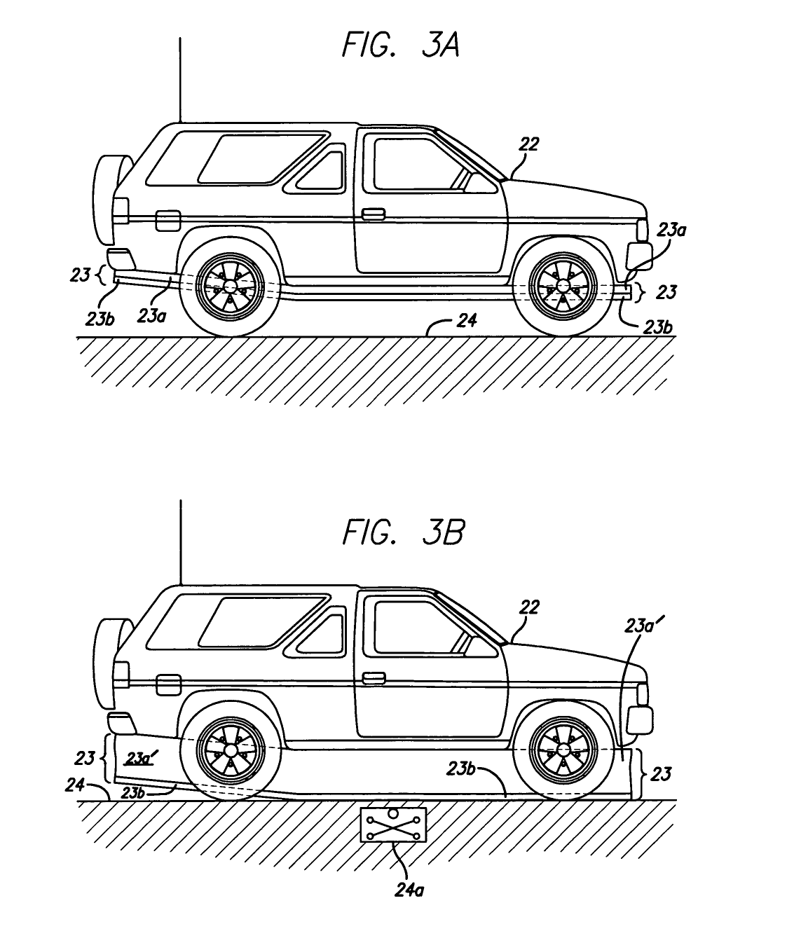

FIG. 3a shows a military vehicle with a stowed uninflated (unexpanded) mattress-shaped inflatable having a bottom-side armor-tiled surface facing the ground. The vehicle 22 is seen having the stowed uninflated inflatable 23 tucked up or compressed against the vehicle underside with plenty of ground clearance underneath it. The inflatable 23 comprises an inflatable portion 23a protected by an armor layer 23b. The ground is depicted as item 24.

Moving now to FIG. 3b, the protective inflatable portion 23a, now depicted as item 23a′, is shown in its now-inflated or expanded state. It can be seen that the inflation has resulted in the armored layer 23b, comprising armored tiles such as Lexan™ plates for example, now moved closer to the ground and now backed by the gas-filled or flowable-material filled inflation cell or cells. The depicted inflatable 23 preferably covers the entire vehicle bottom-side and even protrudes from the underside at the vehicle edges by about a foot. This provides protection against bombs that go off at the side of the vehicle as well. The “mattress” 23 is about 8 inches in total thickness as inflated or expanded, of which about 1-2 inches is the armor layer(s) 23b and about 6 inches is the inflated bag, balloon or cell structure 23a′ behind the armor. Note the undetonated hidden bomb 24a in the road 24 in FIG. 3b.

It should be apparent that the combination of the “floating” or suspended armor layer 23b backed by the gas or fluid-filled bag(s) 23a behind it offers a two-stage protection. I expressly include in the scope of the inventive embodiments, including this one, the idea of adding additional mass to the armor layer such that the armor layer achieves high inertia as well as impenetrability. Such inertia will also help diffuse peak pressures and high shrapnel velocities. This mass could comprise armor material itself or simply additional heavy plates such as tungsten or composite slabs. The backside-inflated volume allows the armor layer 23b some room to deflect or be displaced without passing that shock to the vehicle 22 in a concentrated way.

This third inventive embodiment specifically covers inflatables that allow motion, such as vehicle motion, wherein the inflatable 23 utilizes a combined armored layer 23b and gaseous or fluid-filled layer 23a, the armored layer preferably facing the threat and preferably being displaced toward the threat upon inflation or expansion. Such inflatables 23 can be permanently mounted as well as temporarily mounted as needed. I also contemplate applications wherein the allowed movement comprises sliding of the inflatable 23 and/or its armored layer 23b upon a surface such as a roadway 24, floor, wall or ceiling, for example. In the preferred approach, there preferably is a gap between the inventive device 23 and the roadway or opposed surface 24, thus minimizing friction-assuming such translational or other motion is desired.

This third embodiment does not require an opposed nearby surface 24 such as a roadway with a hidden bomb 24a. One could alternatively, for example, use these devices 23 instead of protective sandbags around a gun position. In this case, the armored surface 23b faces outward, perhaps down the street. In the case of a flak jacket using this embodiment, one would likely at-least wear an expanded vest-like garment covered with an armored coating 23b such as armor tiles, Lexan™ tiles or Kevlar™ materials. In such application, the inflated or expanded space 23a′ behind the armor layer 23b prevents the shock of a projectile hitting the vest from being highly localized, thus avoiding or minimizing impact (as opposed to penetration) related disorientation, pain or upset. Note that the inflated or expanded backing 23a′ of the armored inflatable spreads impact loads widely, much more widely than an existing armored fabric-only flak jacket.

An inherent advantage of this design is that it allows for a device wherein optimal inflatable materials and optimal armor material can be used together, neither compromising the function of the other. Thus, for example, rigid armor material such as metal or ceramic that is not easily bendable or stretchable like the inflatable elastomer can be employed to large advantage. Note that this device hugely dissipates the localized blunt trauma of a person wearing such a device because the armor 23b is essentially backed by an air bag 23a.

I note that it is preferable when using rigid or semi-rigid armor plates or pieces mounted on the threat-face of the inflatable, that the plates do not have large gaps between them and that the plates can preferably bend with respect to their neighbors somewhat at their interfaces. One can achieve these purposes as by overlapping or closely abutting the plates and/or mounting the plates 23b on a flexible armored fabric, the plate/fabric subassembly possibly then being laminated to or attached to the balloon member 23a.

So to summarize aspects of this third embodiment, there is typically an inflatable protective device having at least one armored, puncture-resistant or projectile-resistant material or layer 23b facing or presented to a threat which is in turn mounted upon an underlying shock-absorbing member 23a comprising:
(a) an underlying inflatable member capable of absorbing shock and spreading impacting loads situated adjacent or facing the user being protected; and
(b) at least one segment, section, layer or piece of armored or puncture-resistant material overlying or attached to the inflatable member and facing a threat,
   the combination of the overlying armored layer and the underlying inflatable member providing a two-stage protective system of overlying penetration resistance and underlying energy-absorption and impact energy-spreading.

Options and choices relevant to this third embodiment include, for example, one or more of the following:
(a) a person may wear the device;
(b) a person may seek protection behind the device;
(c) the device may protect a vehicle or occupant thereof;
(d) the device may protect a friendly person holding or manning a position;
(e) the device may be pre-inflated before use;
(f) the device may be inflated for use;
(g) the device may be deflatable after use;
(h) the device may be employed in the manner of a sandbag by shielding a user from enemy fire;
(i) the device may be inflated in response to an alarm, a sensed danger or a command;
(j) the inflatable member may be inflated with any one or more of a person's breath or exhalation, by a liquid or foam, by a liquid or gel, by a pump or gas source, or by a chemical gas-producing means;
(k) the armored layer may comprise multiple layers of armored fabric or fiber-based material;
(l) the armored layer may comprise at least one layer of armor plates or tiles which are preferably overlapped with each other;
(m) the device may fit or be fittable to the general physical form of the wearer or user;
(n) the device may be mounted to a vehicle and inflated while mounted to the vehicle;
(o) the device may be inflated to protect a friendly person under potential or actual fire;
(p) the device may have replaceable or separable armor-portions;
(q) the device may be automatically inflated or deflated;
(r) the inflation pressure may be adjustable;
(s) the user is being protected from a gunshot, blast or other projectile;
(t) the user's vehicle is being protected from a gunshot, blast or other projectile;
(u) the user wears the device uninflated until it is inflated for use;
(v) the act of inflation reduces a peak-pressure or a potential trauma caused by an impact of a bullet, blast or projectile upon the overlying armor layer;
(w) the device protects at least a portion of a user's body;
(x) the device can be carried freehand like a shield as opposed to being fixedly worn;
(y) an armored material includes a ceramic, a glass, a cermet, a metal, a woven fabric, an amorphous metal or glass, or any layered or intermixed sequence or set of penetration-resistant materials; and
(z) an inflatable member includes an elastomeric or polymeric bladder, bag or film.

Again, although a layered armor/impermeable construction is preferred we include in the scope a mixed, composite or otherwise intermingled material comprising at-least an armoring constituent and a permeability-minimizing constituent. Typically, the permeability minimizing constituent will offer some flexibility or formability to a less-flexible armor constituent distributed in or upon it. However the scope is not limited to inflexible armored constituents.

So it should be apparent that relative to the second embodiment, these third embodiment inflatables are more of a directional threat protection device and not devices to necessarily pin persons in position. In general, I expect the second embodiment pinning devices to utilize semiflexible armored materials such as armored fabrics, whereas the third embodiment directional-protection inflatables may even utilize completely rigid or non-flexible armored overlayers comprising, for example, ceramic tiles. The third embodiment, however, may optionally utilize either flexible or inflexible armoring materials.

### Fourth Embodiment

The fourth and last inventive embodiment is one I call involuntary floating threat-designation (IFTD):

In this approach, assume a situation wherein a threat, without (or even with) his knowledge, is dynamically “physically” marked or tagged as a threat, possibly even as he moves or attempts to hide. This “marking” enables a host of threat-neutralization means to be employed selectively against the threat such that others are not harmed. The biggest problem for rescuers is to first identify and to second selectively neutralize the terrorist. By pre-marking the threat, human and/or automated interdiction means can be selectively targeted without delay, perhaps even to a preferred most-vulnerable portion(s) of the threats body, such as his head or chest.

In my preferred fourth embodiment, I utilize laser, ultraviolet or infrared beams to selectively illuminate or designate the threat. These are preferably not visible to the naked eye, even in smoke, and are chosen to have reasonable propagation even in smoke. The threat himself is preferably typically not aware of, if or from what angle(s) he is being designated. Given that the threat is marked, he can be neutralized using infrared-homing lethal devices or infrared-designator aiming devices mounted on the weapons of rescuers or elsewhere in the incident space itself. There is nothing that a terrorist can do in a short period of time to stop such a redundant tracking system other than immediately detonate a bomb. I have already mentioned how the second (or even third) embodiment can provide some bomb protection.

In my preferred fourth embodiment, I have multiple optical designators (markers or taggers), preferably including many dummy designators such that optical blockage or destruction of any significant number of the designators is impractical for the threat to undertake in a short time. On a closed-cabin passenger liner like a 747, one could, perhaps, have 200-500 real plus fake designators, of which perhaps one-third are real and functional. In this fourth embodiment, I preferably have either a protected piloting crew or a ground crew aiming the designators based on video imagers ideally co-integrated with the designators. Software algorithms can also or instead be used to find and/or “lock-onto” such a moving threat. In this manner, even multiple threats can be marked, despite their moving around. I particularly note that single chip cameras and beam-formers utilizing digital-mirror chips available from Texas Instruments are markedly decreasing in cost. The use of infrared imaging cameras to see in smoke and to see an infrared “mark or tag” is expressly included in the scope of this embodiment. Thus, the terrorist purposely filling the cabin with smoke will not deter operation of the system. Note two other aspects of this designation embodiment. The first is that one might even favorably fire a shot(s) or other projectile at the terrorist through the plane body knowing his exact dynamic position inside. The second is that even if the terrorist surrounds himself with human shields, one now at least knows exactly where each such terrorist is, the first half of what needs to be done in every case.

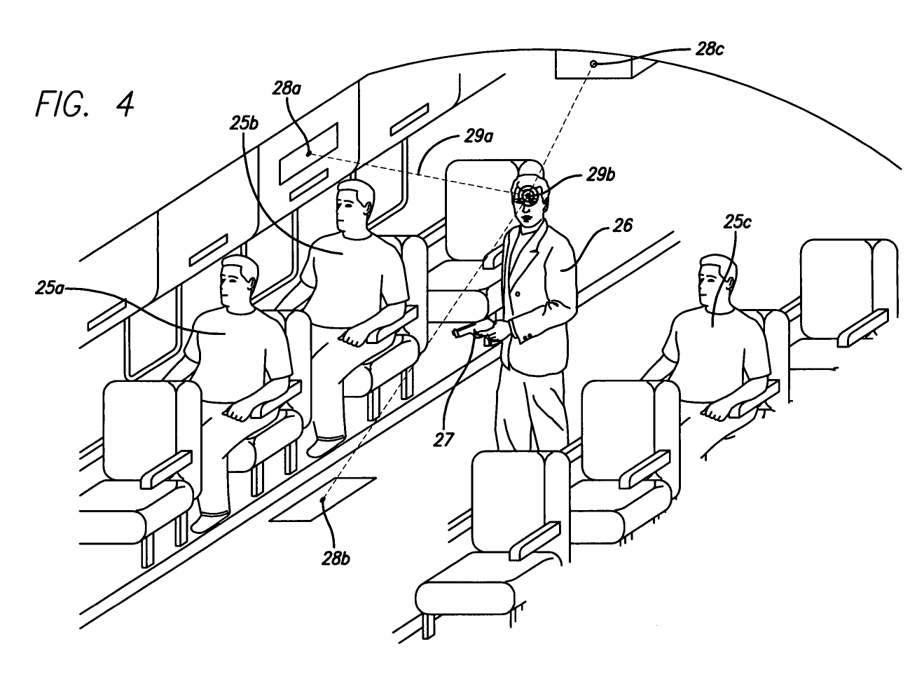

I depict this fourth inventive embodiment in FIG. 4. Therein are seen innocent passengers 25a, 25b and 25c, a terrorist 26 holding a gun 27, designator/camera units 28a on the walls, 28b on the floor, 28c on the ceiling, an invisible designation beam path 29a, and a impacting designation beam upon the terrorist's head in the form of bulls-eye 29b. In this example, the designators and cameras are co-integrated in the various units 28a, 28b, 28c. In preferred embodiments, the camera can visualize both individuals and the designation spot (bulls-eye) such that users of the designation system can verify proper targeting. A single combination camera or the use of both visible and IR cameras is possible.

I emphasize that this embodiment simply labels the terrorist for appropriate treatment as judged by rescuers; it does not itself neutralize the terrorist. I emphasize that the goal is to preferably invisibly label the terrorist with a high signal-to-noise ratio and I believe this can be achieved, especially since there are multiple designators in the aircraft or other at least partly confined space. One may equip the laser or directed-light designators with more than one selectable IR frequency and even hop between such frequencies. In this manner, it would be quite difficult for even a prepared terrorist to have his own designator with which to confuse the system if not designate innocent passengers. I emphasize that a large total number of real or (real plus fake) units is recommended, as the system can designate for a while before the terrorist can block all designators and/or cameras. Use of a variety of hidden cameras and designators is even more encouraged to avoid terrorist interference with operation. I include in the scope of this embodiment the use of other types of cameras, including terahertz electromagnetic-imaging devices now under development. Ideally, not only are there several hundred such units but they are all hidden behind IR transparent paneling or glazing that is impact resistant and tamper-proof. Ideally, such paneling or glazing is everywhere, so one does not know where to start or stop looking. Preferably it will not be obvious behind which panels or walls the sensors are hidden-and indeed IR transparent panels which appear opaque are possible and advisable. We would not want the terrorist to defeat the system by taping over a few suspicious (to him) panels or walls.

What this embodiment has going for it is the plunging cost of the components required. Such cameras and/or designators might be hardwired, networked or wirelessly connected. One could even include one in each seatback and each window glazing as well as in the other suggested areas. Obviously, the system user would know which camera/designator(s) he is utilizing based on a floor plan or seat number, for example.

I particularly anticipate the development of IR or other designator-seeking non-lethal and lethal intervention means. These may comprise, for example, handheld weapons with IR scopes, handheld launchers that launch IR seeking projectiles or intervention devices or even IR activated smart particles or nanobots. What they all have in common is that they utilize the designation pattern to find the unfriendly person(s). One could likewise anticipate an infrared-homing Taser™-like or electrically-stunning electrical incapacitation device.

I also anticipate the potential use of software that allows one or more cameras and/or designators to recognize and/or continue tracking a harmful individual. This could, for example, recognize the terrorist's face, head, weapon or article of clothing. I note that the designators may be operated as by a protected aircraft pilot in the cockpit or even a person on the ground. They may even be automated such that they look for an individual whose features are known, perhaps by a prerecorded boarding imaging and (optionally) voice-recording activity.

Finally, I anticipate the terrorist causing the shutting-off or destruction all cabin lights in an effort to go unseen. To counter this, I expressly include the use of IR or other preferably invisible radiation to illuminate individuals (or large areas) for potential tagging of selected terrorists. Such illuminating radiation lets the observation cameras work so the target can be found. These illuminator(s) may be separate or part of my camera/designator units. The designator is then pointed upon or at the terrorist. The designator pattern radiation or light and the camera light may or may not overlap each other's spectra. In any event, the designator pattern will at least be visible to the intervention means that home-in on it or utilize it for targeting. Preferably, the camera system will also at least let the friendly user or rescuer know where on the terrorist's body the designation is placed, either by viewing in that wavelength and/or by simply having crosshairs indicating where the pattern is placed. The system user would likely have a display upon which he can view cameras in rotation and can then, using a joystick or touchscreen, for example, hold the designator pattern upon the terrorist seen in the camera or video image. For example, the pilot of an aircraft in a protected cockpit could view such images on one of his existing CRTs or flatscreen displays. I stress that with appropriate robust software, it may be possible to have the system operate in cooperation with lethal or incapacitating homing weapons while not requiring a human rescuer to visually view the terrorist or visually locate the crosshairs, Certainly, at some point in time, recognition software will be sufficiently robust that the risk of that would become acceptable given the alternatives.

So, by way of summarizing this fourth embodiment, a system is provided that is capable of target-designating or tagging a potentially or actually harmful person, possibly located among innocent persons or potential victims, for neutralizing or lethal action comprising:
(a) an imaging means allowing for imaging persons including the harmful person or persons; and
(b) a target-designator or tagging means allowing for designation or targeting of an imaged person deemed to be or to potentially be harmful,
   the imaging means providing information useful to the aiming of the target designation or tagging means and the designation or tagging means illuminating the harmful person in a manner preferably invisible to the unaided eye;
   the designation or tagging illumination thereby available to guide the action of lethal or non-lethal force or agents directed at the harmful person; and
   the designation or tagging being directed or aimed by one or both of the systems own intelligence or by a user of the system.

Further the system may provide for any of:
(a) one or more imaging means being hidden or otherwise discretely situated such that it is not easily found and destroyed;
(b) one or more designation or tagging means being hidden such that it is not easily found and destroyed;
(c) an imaging means and a designation or tagging means or device being co-integrated or are the same entity;
(d) at least one of an imaging means or a designation or tagging means utilizing infrared, ultraviolet, terahertz imaging, ultrasound or other human-non-visible illumination or radiation;
(e) a designation or tag being written upon or projected upon a harmful person can be viewed and directed or aimed using one or more of the imaging means;
(f) multiple imaging devices or multiple designation/tagging devices are utilized, possibly one or more of them being fakes, to confound or delay the harmful person in his attempt to defeat or destroy the system;
(g) a pilot or crew-member of a craft or vehicle operating one or both of at least one imaging device or at least one designation or tagging device;
(h) a user remote from the harmful person operating one or both of at least one imaging device or at least one designation or tagging device;
(i) a harmful person being followed by at least one of at least one imaging device and/or at least one designation or tagging device;
(j) a designation or tagging radiation or illumination being projected upon a harmful person, preferably upon a vulnerable area;
(k) the system utilizes facial recognition and/or voice recognition technology in any manner;
(l) the system utilizes facial recognition data gathered at an earlier time than the incident involving the current harm or potential harm;
(m) any of software, algorithms or artificial intelligence supports the identification or tracking of one or more harmful persons;
(n) the system automatically finds and designates/tags a harmful person based on descriptive information provided by a system user such as an earlier facial or voice recognition event;
(o) rescuers neutralize the harmful person, directly or indirectly, using weaponry, offensive measures or agents which home in on the designation-mark or tag placed upon the harmful person by the system or by a user;
(p) a harmful person is imaged and/or tracked by multiple imaging devices or designation/tagging devices in a manner increasing the confidence with which the harmful person can selectively be designated or tagged;
(q) a harmful person is imaged and/or designated/tagged from multiple directions at the same time;
(r) a harmful person's spatial position is provided to rescuers who direct lethal or neutralizing force or agents upon the person from inside or from outside the space using the position information in support of targeting the harmful person; and
(s) sound, speech or voice recognition is also used to further identify the harmful person.

I believe that these are new and technically executable approaches to dealing with harmful individuals and situations and have the implementation advantage of plunging component prices and practical technology. It should be apparent that one or more of the embodiments may be used together. As an example, the fourth embodiment could be utilized to trigger the second embodiment in a selected region of an airplane. Likewise, the first embodiment could allow for friendly forces to approach a hijacked aircraft such that the second and/or fourth embodiment could be practiced.

What I claim is:

1. A flyable unmanned craft useful for one or more disruptive purposes of i) interfering with potential or actual lethal fire coming from an enemy, ii) tracking or locating an enemy, iii) target-designating an enemy, iv) delivering lethal or incapacitating force to an enemy, or v) delivering psychological measures to an enemy, comprising:
(a) a buoyant or powered-lift airborne craft with a hovering capability which can at least one of be spatially positioned to disruptively block an enemy field-of-view, block an enemy field-of-fire, target-designate an enemy, incapacitate an enemy, or deliver neutralizing psychological measures to an enemy;
(b) the craft having damage tolerance or resistance to at least small-arms enemy projectile impacts in terms of substantially maintaining its airworthiness despite at least some such impacts;
(c) the craft having spatial positioning and/or propulsion means which allow it to substantially maintain or correct the desired position, positions or flight-path despite interfering projectile impacts or wind conditions; and
(d) the craft, whether remotely-guided, self-guided or both, thereby offering a means to usefully disrupt or incapacitate said enemy's ability to inflict harm on friendly forces or persons,
the enemy being defined as a person at least apparently willing to do or direct harm to friendly persons, forces or strategic facilities, the friendly persons, forces or facilities being anywhere.

2. The craft of claim 1 wherein by hovering capability is meant that the craft can do at least one of the following:
(a) maintain an airborne spatial position or occupy sequential positions for a period disruptive to the enemy or to his potential harmful intentions,
(b) maintain a blocking position between the enemy and at least one friendly as one or both of them moves;
(c) maintain positions in the immediate near-field of an enemy regardless of movements of friendly forces, said near-field position being disruptive to the enemy intentions and/or his desire to retain cover;
(d) follow an enemy from a standoff distance including having the capability to remain substantially stationary if the enemy is stationary;
(e) provide a stable platform for sensors or offensive measures to be directed at the enemy from or with the help of the craft; and
(f) keep its center of gravity in a fixed spatial position but not necessarily keeping its orientation constant.

3. The craft of claim 1 wherein any of:
(a) the craft is at least partially buoyant at at least one point during deployment, partially-buoyant meaning at-least some amount of lift less than or equally to the crafts total weight is provided;
(b) the craft has a lift-providing means possibly consuming power to provide said lift;
(c) the craft has one or more aerodynamic control surfaces;
(d) the craft has at least one of projectile-resistant or puncture-sealing features;
(e) the craft has at least one of a positional, spatial, distance, orientation, altitude or inertial sensor;
(f) the craft has a propulsive position or orientation correction or maintenance means; and
(g) the craft utilizes gyros or accelerometers to detect or maintain a spatial orientation or position.

4. The craft of claim 1 wherein any of:
(a) the craft is remotely controllable at least at one point during its deployment;
(b) the craft is self-controllable at least at one point during its deployment;
(c) the craft is self powered or internally powered at any point;
(d) the craft is powered via an umbilical or other directed or routed external energy source;
(e) the craft includes self-guidance or self-navigation features;
(f) the craft is capable of at least one of translating, climbing, descending, rolling, yawing or pitching about or along one or more craft axes;
(g) the craft utilizes a propulsive thrust directed at least partially vertically to counteract gravity and provide an element of lift; and
(h) the craft utilizes any of optical, laser, video or acoustic sensors to determine at least one distance or orientation useful to an operative function of the craft.

5. The craft of claim 1 wherein any of:
(a) the craft provides at least visual blockage or interference of an enemy's existing or potential field-of-view or field-of-fire;
(b) the craft provides blockage or interference of or with enemy fire or enemy target-designators;
(c) the craft supports, suspends or dispenses visual or projectile-blocking screens, sheets or structures;
(d) the craft includes an offensive or defensive lethal or incapacitating weapon of any type;
(e) the craft includes an offensive or defensive gas, spray, aerosol, chemical, irritant, Taser™-like device, flash grenade or blinding laser;
(f) the craft includes a means of optically, electromagnetically or acoustically finding or tracking an enemy;
(g) the craft includes an automatic algorithm to either follow an enemy or to maintain a blocking position interfering with the enemies ability to harm friendly forces; and
(h) a craft positioning means takes into account at least one of the position of the enemy or the position of a friendly person to offer useful protection to said friendly or friendlies from said enemy.

6. The craft of claim 1 wherein the craft is any of:
(a) at least partially inflated or filled with a gas, vapor or foam;
(b) at least partially assembled from two or more modules or subsections;
(c) has one or more modular, detachable or exchangeable propulsive means, enemy tracking means, weapons means, navigation means or flight-control means;
(d) is of a size such that when placed in the near-field of an enemy substantially blocks his field-of-view or field-of-fire; and
(e) is of a size such that upon placement at a spatial position offers coverage to friendly forces, said position or positions being anywhere between the friendly and supposed or known enemy positions and chosen for maximum situational benefit.
f) is utilized with an offensive intention by a friendly user or persons

7. The craft of claim 1 wherein any of:
(a) the craft has an internal or external skin, membrane or bladder including a substantially gas-impermeable layer;
(b) the craft has an internal or external skin including a woven or non-woven substantially bullet-proof or puncture-resistant fabric;
(c) the craft has an internal or external skin with one or more armored tiles, plates, layers or coatings;
(d) the craft has a self-sealing internal or external skin layer which at least partially seals punctures;
(e) the craft has a fire-resistant internal or external skin layer; and
(f) the craft has a vital navigation or propulsion means hidden inside or behind a projectile-resistant skin or housing.
g) the craft has a skin which is a mixture or composite of at-least one substantially impermeable material and one impact-protection or armoring material

8. The craft of claim 1 wherein any of:
(a) a wired or wireless electromagnetic or optical communication link is utilized between an operator of the craft and the craft, regardless of the location of said operator;
(b) an on-site craft operator is present;
(c) a remotely situated craft operator is employed;
(d) a craft operator directs lethal or non-lethal force means or psychological measures emanating from the craft upon or at the enemy;
(e) the craft supports a means to communicate with an enemy or vice-versa;
(f) the craft has at its disposal electronic or software-based means of determining, arriving at, or maintaining a spatial position or positions;
(g) the craft has at its disposal electronic or software means for directing or activating lethal or non-lethal fire, interdiction means, neutralization means or psychological countermeasures;
(h) the craft has an ability to fly a predetermined path or trajectory which is either predetermined or is determined with knowledge of an enemy or friendly position, action or intention; and
(i) the craft has an ability to inform a controller or friendly that it has spotted or located an enemy.
j) the craft controller himself is being protected by the craft

9. The craft of claim 1 wherein any of:
(a) the craft is flown, parked or hovered in the near-field of an enemy to substantially interfere with his ability to one or more of see, fire at or target-designate friendly forces;
(b) the craft is flown through, parked in or hovered in a position, positions or a trajectory which offer protective blocking cover for friendly forces;
(c) the craft, being in an enemy's near-field, causes an enemy explosive projectile to detonate in the near-field of said enemy;
(d) the craft is equipped with any of redundant navigation, propulsion, armoring or flying means to accommodate some amount of damage without mission failure;
(e) the craft utilizes any of rockets, turbines, jets, propellers, rotating blades, fans or lighter-than-air gases for any laterally or vertically propulsive or aerial suspension or lift purpose;
(f) the craft offers protective cover to friendly forces from incoming fire; and
(g) a craft propulsion means offers both lift and lateral propulsive thrust, whether simultaneously or sequentially.

10. The craft of claim 1 wherein any of:
(a) the craft has at least one aerodynamic shaped surface or member, whether manipulatable or not;
(b) the craft has at least one aerodynamic control surface which is manipulatable;
(c) the craft has at least one directable or fixedly directed thruster, rocket, jet, rotor, propeller, blade or propulsion means providing any of lateral or vertical thrust;
(d) the craft is between 5 feet and 20 feet long;
(e) the craft is longer than its average width, height or diameter;
(f) the craft includes two or more isolated buoyancy chambers or volumes, thereby offering a redundancy to its buoyant forces;
(g) the craft has an on-board target designator for directing weaponry, which weaponry may or may not be situated on or in the craft itself;
(h) the craft has the general shape of a balloon, dirigible, blimp, wing, cylinder, sphere or airplane;
(i) the craft operates in synchrony or in cooperation with at least one other such craft; and
(j) the craft has at least one tether, umbilical or cable which at least one of provides in at least one direction power, fuel, data transmission, physical anchorage, a buoyancy gas, lethal or non-lethal substances such as knockout or teargas, or a redundant service to said craft.

11. The craft of claim 1 wherein the craft is operated by one or more of:
(a) a controller within at least occasional visual or video sight of the craft;
(b) a controller within communication-link range of the craft;
(c) a controller in an aircraft flying overhead or nearby;
(d) an artificial intelligence means on-board or off-board the craft;
(e) a combination of human inputs and software algorithms or programs resident on-board or off-board the craft;
(f) a member or members of a friendly force; and
(g) software or algorithms adaptive to at least one aspect of enemy or friendly behavior or positioning, said software or algorithms being resident on-board or off-board the craft.

12. A system offering protection to victims or potential victims of any one or more of terrorism, criminal behavior and disasters, said system providing said protection via one or more of i) immobilization of a perpetrator, if any, ii) protective physical immobilization of potential or actual victims of a disaster, iii) protective physical shielding of actual or potential victims of a disaster, iv) physical blockage of dangerous flying projectiles or debris whether coming from a perpetrator or as a consequence of an actual or potential disaster or v) visual blockage of the perpetrator such that he cannot easily act against victims, comprising:
(a) an at least partially confined space in which said protection is to be offered, confined meaning the space has at least two generally opposed surfaces;
(b) at least one inflatable member inflatable into the confined space and toward a generally opposed surface upon a triggering signal or event;
(c) the at least one inflatable member providing at least one of said beneficial immobilization, shielding, blockage or visual disruption;
(d) the at least one inflatable member remaining inflated for a period of seconds to minutes as by continued inflow of inflation media or as by inflow and subsequent substantial sealing of in-flowed media; and
(e) said inflation, as necessary, accompanied by appropriate venting of air in the confined space to avoid over-pressurization of said space that would itself permanently harm said victims directly or indirectly.

13. The system of claim 12 wherein any of:
(a) two or more inflatable members are employed in temporal or physical cooperation with each other;
(b) one or more inflatable members forces or holds a perpetrator into or in a position from which he can do little or no harm;
(c) one or more inflatable members blocks a bullet, projectile or bomb blast from harming or killing at least one potential victim;
(d) one or more inflatable members beneficially pins and protects potential victims from being thrown about during an actual or potential impact, structure collapse or structure disintegration;
(e) one or more inflatable members isolates a perpetrator from his potential victims in terms of his reach, his view, his gunfire or his explosive blast potential;
(f) one or more inflatable members is inflated in a closed or confined space which is vented to allow said inflation without dangerous overpressure;
(g) one or more inflatable members is inflated on or in an aircraft, ship, train, taxi, bus, automobile or in any vehicle; and
(h) one or more inflatable members pins or clamps a perpetrator or victim against any surface in or defined by the confined space or between two or more inflatables, or both.

14. The system of claim 12 wherein any of: a) said as-inflated period provides time for rescuers to intervene with lessened danger to themselves or lessened danger to potential innocent victims, and b) the actual time to substantially fully inflate an inflatable is between 50 milliseconds and 2000 milliseconds.

15. The system of claim 12 wherein said triggering signal or triggering event is provided by any one or more of: a) an activated alarm, b) a person observing potentially criminal behavior or disaster in the making, c) a pilot or crew member of a craft, d) a gunshot, e) a detonation of any type, f) a warning regarding an impending impact of the craft in which potential victims are riding, g) a warning regarding the impending arrival of an earthquake, fire, tornado or other dangerous event, and h) any crash-detection or crash-warning device.

16. The system of claim 12 wherein any of:
(a) an inflatable member is puncture resistant or fire-resistant;
(b) an inflatable member emits, vents or leaks either or both of breathing gas, knockout gas or a sedative gas or vapor;
(c) an inflatable member prevents flying burning fuel from coating or being breathed by passengers;
(d) one or more inflatable members offers blast protection to one or more potential victims;
(e) two or more inflating or inflated inflatables physically clamp, pin or squeeze a potential victim or a perpetrator in the interfaces of said inflatables or between one or more inflatables and a wall, floor, ceiling, bulkhead or furniture item of the confined space;
(f) one or more inflatable members are inflated from or out of one or more of a ceiling, wall, floor, bulkhead or item of furniture in the confined space; and
(g) one or more inflatable members is delivered or fired into the confined space in a substantially uninflated condition and then fully inflated, this approach avoiding storage of at least some uninflated members in the space itself.

17. The system of claim 12 wherein one or more inflatable members at least one of:
(a) is filled with a flowed gas, foam or vapor;
(b) is filled with a one-time pyrotechnic gas or vapor-producing device;
(c) is filled with gas or vapor by the chemical reaction of constituents which are mixed;
(d) is filled over a total period of between 50 and 2000 milliseconds total fill-time;
(e) is filled no faster than 100 milliseconds total fill-time period;
(f) is filled with a breathable gas or vapor mixture which, at least in part, is leaked or vented into the intra-inflatable spaces;
(g) is filled, at least in part, with a gas, vapor or aerosol used to render persons in the inflated volume or region unconscious, passive or at least minimally resistant or sedated; and
(h) inhibits sliding motion of a person or of another inflatable across an inflated inflatable surface.
i) is filled with a liquid in an application wherein the weight of the liquid does not harm victims or potential victims

18. The system of claim 12 wherein any of:
(a) a subset of inflatable members is inflated based on the location of a known or anticipated threat within, entering or leaving the confined space;
(b) rescuers can deflate one or more inflatable members on demand;
(c) the at least one inflatable member remains inflated until a danger has passed;
(d) the at least one inflatable member is optically opaque;
(e) the at least one inflatable member is inflated, at least in part, by the sucking action of a vented or reduced pressure confined space;
(f) the at least one inflatable member has custom shapes optimized for its location and interaction with adjacent or opposed inflatable members, walls, ceilings, floors, bulkheads or furniture items; and
(g) the at least one inflatable member is inflated with a foam or other hardening filler material offering some rigidity to the inflated inflatable at least after a short period.

19. The system of claim 12 wherein at least one of:
(a) two or more inflatable members are inflated from a common inflation source;
(b) two or more inflatable members are inflated from two or more different inflation sources;
(c) two or more inflatable members are triggered by a single trigger event; and
(d) two or more inflatable members are triggered by two or more trigger events.
e) two or more inflatables fill in a timed sequence

20. The system of claim 12 wherein any of:
(a) an inflatable member is fire resistant or fire retardant;
(b) an inflatable member is tear resistant or puncture resistant;
(c) an inflatable member is bullet proof or bullet resistant;
(d) an inflatable member, when inflated, cannot be easily moved by an inflatable member-pinned or clamped individual;
(e) an inflatable member has a high burst pressure;
(f) an inflatable member has a controlled leak rate into the confined space;
(g) an inflatable member is substantially sealed from deflating after inflation; and
(h) an inflatable member has more than one layer, such as a gas sealing layer and an overlying puncture-resistant layer.
i) an inflatable member utilizes at-least one substantially impermeable material and at-least one physically-protecting material, whether the two materials are layered, intermingled or intermixed

21. An inflatable protective device having at least one armored, puncture-resistant or projectile-resistant material or layer facing or presented to a threat which is in turn mounted upon an underlying shock-absorbing member, comprising:
(a) an underlying inflatable member capable of absorbing shock and spreading impacting loads and situated adjacent or facing the user being protected; and
(b) at least one segment, section, layer or piece of armored or puncture-resistant material overlying or attached to said inflatable member and facing a threat,
the combination of the overlying armored layer and the underlying inflatable member providing a two-stage protective system of overlying penetration resistance and underlying energy-absorption and impact energy-spreading.

22. The protective device of claim 21 wherein any of:
(a) a person wears the device;
(b) a person seeks protection behind the device;
(c) the device protects a vehicle or occupant thereof;
(d) the device protects a friendly person holding or manning a position;
(e) the device is pre-inflated before use;
(f) the device is inflated for use;
(g) the device is deflatable after use;
(h) the device is employed in the manner of a sandbag by shielding a user from enemy fire; and
(i) the device is inflated in response to an alarm, a sensed danger, a triggering event, or a command.

23. The protective device of claim 21 wherein any of:
(a) the inflatable member is inflated with any one or more of a person's breath or exhalation, by a liquid or foam, by a liquid or gel, by a pump or gas source, or by a chemical gas-producing means;
(b) the armored layer comprises multiple layers of armored fabric or fiber-based material;
(c) the armored layer comprises at least one layer of armor plates or tiles which are preferably overlapped with each other; and
(d) the device fits or is fitted to the general physical form of the wearer or user.
e) the device fits or is fitted to the general physical form of a vehicle or structure

24. The protective device of claim 21 wherein any of:
(a) the device is mounted to a vehicle and is inflated while mounted to the vehicle;
(b) the device is inflated to protect a friendly person under potential or actual fire;
(c) the device has replaceable or separable armor-portions;
(d) the device is automatically inflated or deflated; and
(e) the inflation pressure is adjustable.
f) the device is mounted to a structure such as a portion of a building and is inflated to improve the protection offered by that portion of the structure
g) the device, after inflation, protects what was previously an open or exposed door, window or passage

25. The protective device of claim 21 wherein any of:
(a) the user is protected from a gunshot, blast, shrapnel or other projectile;
(b) the user's vehicle is protected from a gunshot, blast, shrapnel or other projectile;
(c) the user wears the device substantially uninflated until it is inflated or further-inflated for use;
(d) the act of inflation reduces a peak-pressure or a potential trauma caused by an impact of a bullet, blast, shrapnel or projectile upon the overlying armor layer;
(e) the device protects at least a portion of a user's body; and
(f) the device can be carried freehand like a shield as opposed to being fixedly worn.

26. The protective device of claim 21 wherein any of:
(a) an armored material includes a ceramic, a glass, a cermet, a metal, a woven fabric, an amorphous metal or glass, or any layered or woven sequence of penetration-resistant materials; and
(b) an inflatable member includes an elastomeric or polymeric bladder, bag or film or any other deformable and substantially impermeable material
c) inflation of the inflatable still allows motion of a protected entity
d) inflation causes a protected entity to have limited or no motion.

27. A system that is capable of target-designating or tagging a potentially or actually harmful person, possibly located among innocent persons or potential victims, for neutralizing or lethal action comprising:
(a) an imaging means allowing for imaging persons including the harmful person or persons; and
(b) a target-designator or tagging means allowing for designation or targeting of an imaged person deemed to be or to potentially be harmful,
the imaging means providing information useful to the aiming of the target designation or tagging means and the designation or tagging means illuminating the harmful person in a manner preferably invisible to the unaided eye,
the designation or tagging illumination thereby available to guide the action of lethal or non-lethal force or agents directed at the harmful person, and
the designation or tagging being directed or aimed by one or both of the systems own intelligence or by a user of the system.

28. The system of claim 27 wherein any of:
(a) one or more imaging means is hidden or otherwise discretely situated such that it is not easily found and destroyed;
(b) one or more designation or tagging means is hidden or otherwise discretely situated such that it is not easily found and destroyed;
(c) an imaging means and a designation or tagging means or device are co-integrated, are co-located, or are substantially the same entity;
(d) at least one of an imaging means or a designation or tagging means utilizes infrared, ultraviolet, terahertz-electromagnetic, ultrasound or other human-non-visible illumination or radiation;
(e) a designation or tag written upon or projected upon a harmful person can be any of directed, aimed or viewed using one or more of the imaging means; and
(f) multiple imaging devices or multiple designation/tagging devices are utilized, possibly one or more of them being fakes to confound or delay the harmful person in his attempt to defeat or destroy the system.

29. The system of claim 27 wherein any of:
(a) a pilot or crew-member of a craft or vehicle operates one or both of at least one imaging device or at least one designation or tagging device;
(b) a user remote from the harmful person operates one or both of at least one imaging device or at least one designation or tagging device;
(c) a harmful person is followed by at least one of at least one imaging device and/or at least one designation or tagging device;
(d) a designation or tagging radiation or illumination is projected upon a harmful person, preferably upon a vulnerable area;
(e) the system utilizes facial recognition or voice recognition technology in any manner;
(f) the system utilizes facial recognition or voice recognition data gathered at an earlier time than the incident involving the current harm or potential harm;
(g) the system of claim 27 wherein any of software, algorithms or artificial intelligence supports the identification or tracking of one or more harmful persons; and
(h) the system automatically finds and designates/tags a harmful person based on descriptive information provided by a system user such as data from an earlier facial or speech recognition event linked to the person.

30. The system of claim 27 wherein any of:
(a) rescuers neutralize the harmful person, directly or indirectly, using weaponry, offensive measures or agents which home-in on the designation mark or tag placed upon the harmful person by the system or by a user;
(b) a harmful person is imaged and/or tracked by multiple imaging devices or designation/tagging devices in a manner increasing the confidence with which the harmful person can selectively be designated or tagged;
(c) a harmful person is imaged and/or designated/tagged from multiple directions at the same time;
(d) a harmful person's spatial position is provided to rescuers who direct lethal or neutralizing force or agents upon the person from inside or from outside the space using said position information in support of targeting the harmful person;
(e) sound, speech or voice recognition is also used to identify the harmful person;
f) human nonvisible illumination, such as blanket infrared radiation, is utilized to be able to see the harmful person in the dark or in smoke; and
g) the system is capable of tracking the motion of a person across two or more imaging devices or designation devices at a given time or over a time period.
